(19) United States
(12) Patent Application Publication
(10) Pub. No.: US 2013/0312907 A1
(43) Pub. Date: Nov. 28, 2013

(54) SUBSTRATE-BONDING APPARATUS FOR DISPLAY DEVICE AND METHOD FOR MANUFACTURING BONDED SUBSTRATE

(71) Applicant: LG DISPLAY CO., LTD., Seoul (KR)

(72) Inventors: Jae Young OH, Goyang-si (KR); Dae Hoon LEE, Dalseo-gu (KR); Jae Duk JO, Chilgok-gun (KR); Jae Won LEE, Goyang-si (KR); Young Kwang PARK, Chilgok-gun (KR); Ki Hyun KWON, Pohang-si (KR)

(73) Assignee: LG DISPLAY CO., LTD., Seoul (KR)

(21) Appl. No.: 13/681,015

(22) Filed: Nov. 19, 2012

(30) Foreign Application Priority Data
May 23, 2012 (KR) 10-2012-0054532
May 24, 2012 (KR) 10-2012-0055265

(51) Int. Cl. B32B 38/18

(52) U.S. Cl. CPC B32B 38/1858
USPC 156/285; 156/382

(57) ABSTRACT

A substrate-bonding apparatus for a display device, and which includes a chamber unit configured to bond a carrier substrate to a substrate for manufacturing the display device; a first surface plate provided inside the chamber unit and configured to support the substrate; a supporting unit provided inside the chamber unit and configured bring the carrier substrate into contact with the substrate supported by the first surface plate; and a pressure-adjusting unit communicating with the chamber unit and configured to change a vacuum pressure from a low vacuum pressure to a high pressure in multiple steps inside the chamber unit while the carrier substrate is brought into contact with the substrate to bond the carrier substrate to the substrate without adhesive material between the carrier substrate and the substrate.

### CROSS REFERENCE TO RELATED APPLICATIONS

This application claims the benefit of Korean Patent Applications No. 10-2012-0054532 filed on May 23, 2012 and No. 10-2012-0055265 filed on May 24, 2012, which are hereby incorporated by reference as if fully set forth herein.

### BACKGROUND OF THE INVENTION

1. Field of the Invention

The present invention relates to a substrate-bonding apparatus for a display device which facilitates bonding a carrier substrate to a substrate for manufacturing a display device, and a method for manufacturing a bonded substrate.

2. Discussion of the Related Art

Display devices such as a liquid crystal display (LCD), organic light-emitting diodes (OLED), plasma display panel (PDP), and electrophoretic display (EPD) are manufactured by various processes. These processes include scribing a substrate, a taped automated bonding (TAB) process, etc.

Thin substrates are used to manufacture a slimmer display device. However, this method has the following disadvantages. First, the substrate has a low durability due to its thinness. That is, during the scribing process and TAB process, the substrate can be easily damaged, thereby lowering the yield, and increasing manufacturing cost.

A thin substrate with a high durability, for example, tempered glass can be used, but tempered glass is expensive thus increasing the manufacturing cost of the display device.

### SUMMARY OF THE INVENTION

Accordingly, one aspect of the present invention is to provide a substrate-bonding apparatus for a display device and corresponding manufacturing method that substantially obviate one or more problems due to limitations and disadvantages of the related art.

Another aspect of the present invention is to provide a substrate-bonding apparatus for a display device and corresponding method, which prevent a substrate from being damaged during a process for manufacturing a slim display device.

To achieve these and other advantages and in accordance with the purpose of the invention, as embodied and broadly described herein, the present invention provides in one aspect a substrate-bonding apparatus for a display device, and which includes a chamber unit configured to bond a carrier substrate to a substrate for manufacturing the display device; a first surface plate provided inside the chamber unit and configured to support the substrate; a supporting unit provided inside the chamber unit and configured bring the carrier substrate into contact with the substrate supported by the first surface plate; and a pressure-adjusting unit communicating with the chamber unit and configured to change a vacuum pressure from a low vacuum pressure to a high pressure in multiple steps inside the chamber unit while the carrier substrate is brought into contact with the substrate to bond the carrier substrate to the substrate without adhesive material between the carrier substrate and the substrate.

In another aspect, the present invention provides a method of bonding a carrier substrate and a substrate for a display device, and which includes supporting, via a first surface plate provided inside the chamber unit, the substrate; bringing, via using a supporting unit provided inside the chamber unit, the carrier substrate into contact with the substrate supported by the first surface plate; and changing, via a pressure-adjusting unit communicating with the chamber unit, a vacuum pressure from a low vacuum pressure to a high pressure in multiple steps inside the chamber unit while the carrier substrate is brought into contact with the substrate to bond the carrier substrate to the substrate without adhesive material between the carrier substrate and the substrate.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross sectional view of a substrate-bonding apparatus for a display device according to an embodiment of the present invention;

FIGS. 2 to 4 are concept views for explaining a problem occurring when a carrier substrate is brought into contact with a substrate by pushing;

FIG. 5 is a cross sectional view of a substrate-bonding apparatus for a display device which includes a supporting unit according to a first embodiment of the present invention;

FIGS. 6 and 7 are perspective views of the supporting unit according to an embodiment of the present invention;

FIGS. 8 and 9 are cross sectional views illustrating an operation state for bringing a carrier substrate into contact with a substrate using a supporting unit according to the first embodiment of the present invention;

FIG. 10 is a cross sectional view of a substrate-bonding apparatus for a display device which includes a supporting unit according to a second embodiment of the present invention;

FIG. 11 is a cross sectional view of the supporting unit according to the second embodiment of the present invention;

FIG. 12 is a plane view of a carrier substrate in which a suction force is adjusted according to each section using the supporting unit according to the second embodiment of the present invention;

FIGS. 13 and 14 are cross sectional views illustrating an operation state for bringing a carrier substrate into contact with a substrate using the supporting unit according to the second embodiment of the present invention;

FIG. 15 is a plane view of a carrier substrate, which shows a modified embodiment for adjusting a suction force according to each section using the supporting unit according to the second embodiment of the present invention;

FIG. 16 is a cross sectional view of a substrate-bonding apparatus for a display device which includes a supporting unit according to a third embodiment of the present invention;

FIGS. 17 to 19 are cross sectional views illustrating an operation state for bringing a carrier substrate into contact with a substrate using the supporting unit according to the third embodiment of the present invention;

FIG. 20 is a cross sectional view of a substrate-bonding apparatus for a display device which includes a supporting unit according to a fourth embodiment of the present invention;

FIGS. 21 and 22 are cross sectional views illustrating an operation state for bringing a carrier substrate into contact with a substrate using the supporting unit according to the fourth embodiment of the present invention;

FIGS. 23 and 24 are expanded views illustrating ‘A’ of FIG. 21 for explaining an attaching unit according to an embodiment of the present invention;

FIG. 25 is a bottom view of the attaching unit according to an embodiment of the present invention;

FIG. 26 is a cross sectional view illustrating a first elevating device according to a modified embodiment of the present invention;

FIG. 27 is a cross sectional view illustrating a supporting unit with a separating unit according to the fourth embodiment of the present invention; and

FIGS. 28 and 29 are cross sectional views illustrating an operation state for bringing a carrier substrate into contact with a substrate using the separating unit and attaching unit of the substrate-bonding apparatus according to an embodiment of the present invention.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

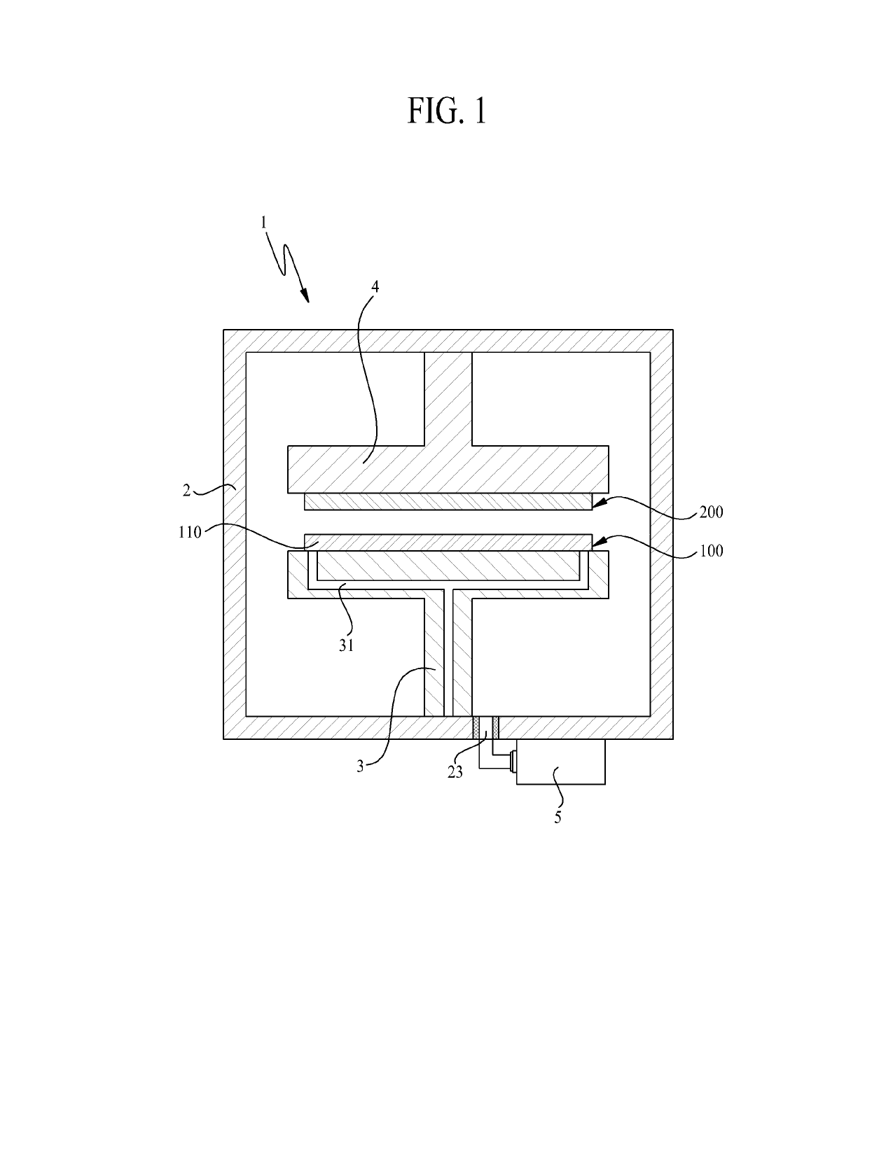

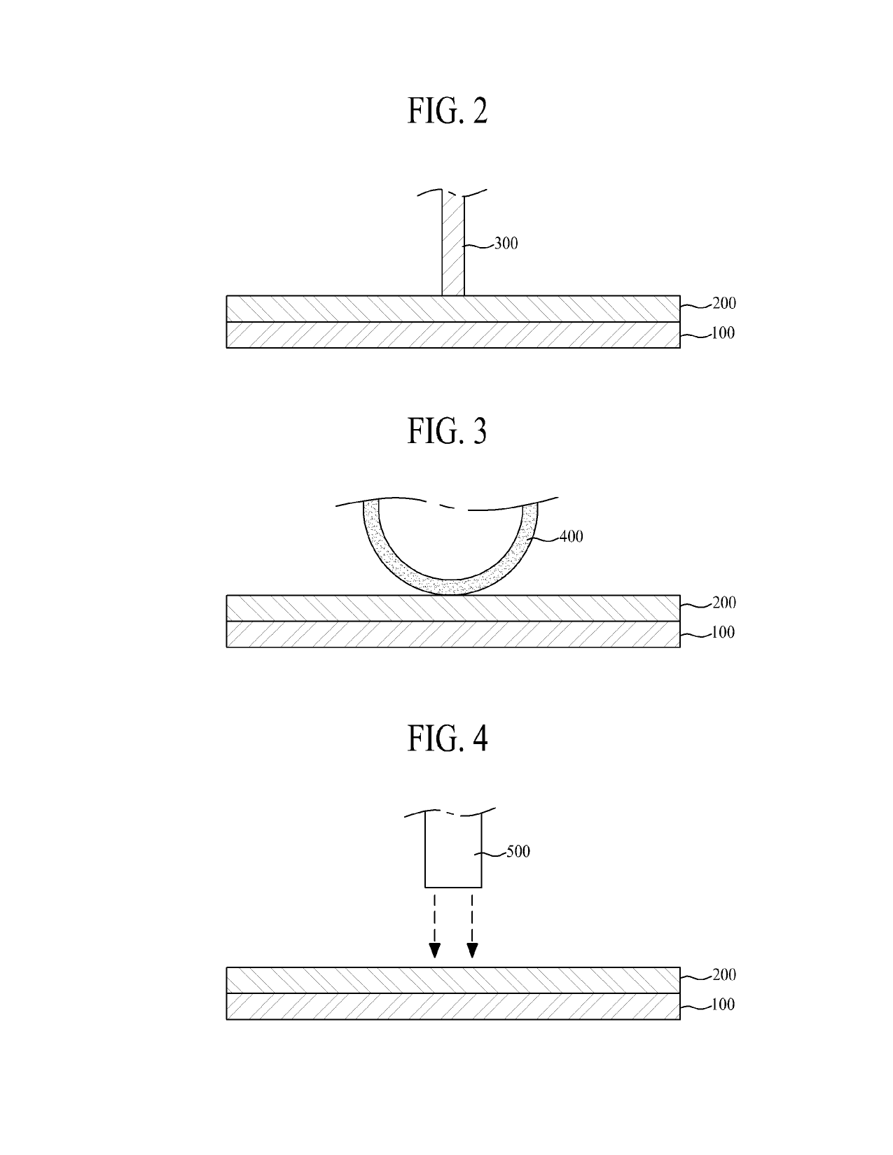

Hereinafter, a substrate-bonding apparatus for a display device according to an embodiment of the present invention will be described with reference to the accompanying drawings. Referring to FIGS. 1 and 2, the substrate-bonding apparatus for a display device 1 (hereinafter, referred to as ‘substrate-bonding apparatus’) according to an embodiment of the present invention bonds a carrier substrate 200 to a substrate 100 for manufacturing the display device.

The substrate 100 can be used for display devices such as a liquid crystal display (LCD), organic light-emitting diodes (OLED), plasma display panel (PDP), and electrophoretic display (EPD). Furthermore, the substrate 100 can be used for a three-dimensional (3D) image display device and be formed of glass. In addition, the carrier substrate 200 is bonded to the substrate 100, to thereby reinforce the durability of the substrate 100.

Accordingly, when the carrier substrate 200 is bonded to the substrate 100, the substrate-bonding apparatus 1 according to an embodiment of the present invention performs a process for manufacturing the display device. That is, even though the substrate 100 is thin, it is possible to prevent the substrate 100 from being damaged when manufacturing the display device. Thus, the substrate-bonding apparatus 1 according to an embodiment of the present invention obtains a high-quality slim display device. Also, even though the substrate 100 can be formed without tempered glass in one embodiment of the present invention, the substrate-bonding apparatus 1 prevents the substrate 100 from being damaged. Accordingly, the manufacturing cost of the slim display device is lowered compared the display device using tempered glass.

Further, the carrier substrate 200 may include a material for reinforcing durability of the substrate 100. For example, the carrier substrate 200 may include glass. A shape of the carrier substrate 200 may also be similar to a shape of the substrate 100. For example, the carrier substrate 200 may be formed in a rectangular plate shape. In addition, the carrier substrate 200 has a thickness sufficient to prevent the substrate 100 from being damaged when manufacturing the display device. For example, the carrier substrate 200 may be thicker than the substrate 100.

However, the carrier substrate 200 may be formed at any thickness within a range to prevent the substrate 100 from being damaged. That is, if the thickness of the carrier substrate 200 satisfies this range, the carrier substrate 200 may be manufactured to be thinner than the substrate 100, or to be roughly identical to the thickness of the substrate 100. Before completing the process for manufacturing the display device, the carrier substrate 200 is removed from the substrate 100, to thereby realize the slim display device.

Referring to FIGS. 1 to 4, the substrate-bonding apparatus 1 includes a chamber unit 2, a first surface plate 3 and a supporting unit 4. In addition, a process for bonding the carrier substrate 200 to the substrate 100 is performed in the chamber unit 2. Also, the first surface plate 3 supports the substrate 100, and the supporting unit 4 brings the carrier substrate 200 into contact with the substrate 100 supported by the first surface plate 3. Accordingly, as the carrier substrate 200 is brought into contact with the substrate 100 supported by the first surface plate 3, the carrier substrate 200 is bonded to the substrate 100.

Next, a method for bringing the carrier substrate 200 into contact with the substrate 100 will be described with reference to FIGS. 2 to 4. First, as shown in FIG. 2, a pushing pin 300 is provided in the supporting unit 4 (see FIG. 1). Accordingly, as the pushing pin 300 moves down toward the carrier substrate 200, the pushing pin 300 pushes the carrier substrate 200 into contact with the substrate 100. However, this method creates partial spots or deformation in the substrate 100, because the pushing pin 300 pushes the substrate 100 in contact with the carrier substrate 200.

Referring to FIG. 3, a diaphragm 400 is provided in the supporting unit 4 (see FIG. 1). Gas is then supplied to the inside of the diaphragm 400, and the diaphragm 400 expands so that the diaphragm 400 pushes the carrier substrate 200 into contact with the substrate 100. However, this method creates partial spots or deformation in the substrate 100, because the diaphragm 400 pushes the substrate 100 in contact with the carrier substrate 200.

Referring to FIG. 4, a spraying device 500 is provided in the supporting unit 4 (see FIG. 1). Accordingly, as the spraying device 500 sprays gas toward the carrier substrate 200, it produces a jetting force that pushes the carrier substrate 200 into contact with the substrate 100. However, this method also creates partial spots or deformation in the substrate 100, because the jetting force affects the substrate 100 in contact with the carrier substrate 200.

As described above, the methods using the pushing pin 300, the diaphragm 400, and the spraying device 500 in FIGS. 2-4 create partial spots or deformation in the substrate 100 that deteriorate the quality of the slim display device. In order to overcome these problems, the substrate-bonding apparatus 1 according to an embodiment of the present invention includes a pressure-adjusting unit 5 (see FIG. 1).

In more detail, when the carrier substrate 200 is brought into contact with the substrate 100, the pressure-adjusting unit 5 lowers a pressure inside the chamber unit 2. Thus, the pressure-adjusting unit 5 discharges gas remaining between the substrate 100 and the carrier substrate 200 from a gap between the substrate 100 and the carrier substrate 200, whereby the carrier substrate 200 is bonded to the substrate 100. Further, the substrate 100 and the carrier substrate 200 may be bonded to each other by a molecular binding and without an adhesive layer between the carrier substrate 200 and the substrate 100.

That is, an adhesive material requires a dispensing and curing mechanism for dispensing the adhesive material on one or both of the carrier substrate 200 and the substrate 100. Thus, an extra piece of equipment is needed and the cost of producing the display device increases. The length of time required to produce the display device also increases when using the adhesive layer.

The present invention solves this problem by molecularly binding the carrier substrate 200 to the substrate 100 without an adhesive layer by adjusting or changing the vacuum pressure from a low vacuum pressure to a high vacuum pressure when the carrier substrate 200 is brought into contact with the substrate 100. That is, the molecules of the carrier substrate 200 interact with molecules of the substrate 100 and become bonded to each other when the pressure changing process of the present invention is performed.

In addition, air bubbles occur between the carrier substrate 200 and the substrate 100 when the carrier substrate 200 is bonded to the substrate 100. Further, the carrier substrate 200 and the substrate 100 are generally large in size and thus air trapped in a center portion of the carrier substrate 200 and the substrate 100 takes times to be removed from the center of the carrier substrate 200 and the substrate 100. Thus, the present invention advantageously changes or adjusts the vacuum state pressure from a low vacuum pressure to a high vacuum pressure step-by-step. This step-by-step process is very effective in removing bubbles between the substrates compared to a single step of increasing the vacuum pressure.

Thus, the substrate-bonding apparatus 1 according to an embodiment of the present invention facilitates bonding the carrier substrate 200 to the substrate 100 supported by the first surface plate 3 without applying a force to the substrate 100 and without adhesive. While the above methods using the pushing pin 300, the diaphragm 400, and the spraying device 500 damage the substrate 100 due to the force applied to the substrate 100, the substrate-bonding apparatus 1 according to an embodiment of the present invention prevents the substrate 100 from being spotted or deformed when bonding the carrier substrate 200 to the substrate 100. Thus, the substrate-bonding apparatus 1 according to an embodiment of the present invention improves the quality of slim display device.

Also, the substrate-bonding apparatus 1 according to an embodiment of the present invention discharges the gas remaining between the substrate 100 and the carrier substrate 200 from the gap between the substrate 100 and the carrier substrate 200 when bonding the carrier substrate 200 to the substrate 100. Thus, the substrate-bonding apparatus 1 prevents bubbles from occurring between the substrate 100 and the carrier substrate 200, thereby improving the quality of slim display device.

Hereinafter, the chamber unit 2, the first surface plate 3, the supporting unit 4, and the pressure-adjusting unit 5 will be described in more detail with reference to the accompanying drawings. Referring to FIG. 1, the chamber unit 2 supports the first surface plate 3. Further, the process for bonding the carrier substrate 200 to the substrate 100 is performed inside the chamber unit 2. As shown in FIG. 1, the chamber unit 2 may be formed in a rectangular parallelepiped with an empty space therein. However, the chamber unit 2 may be formed in any other shape sufficient to provide a space suitable for performing the aforementioned process for bonding the carrier substrate 200 to the substrate 100.

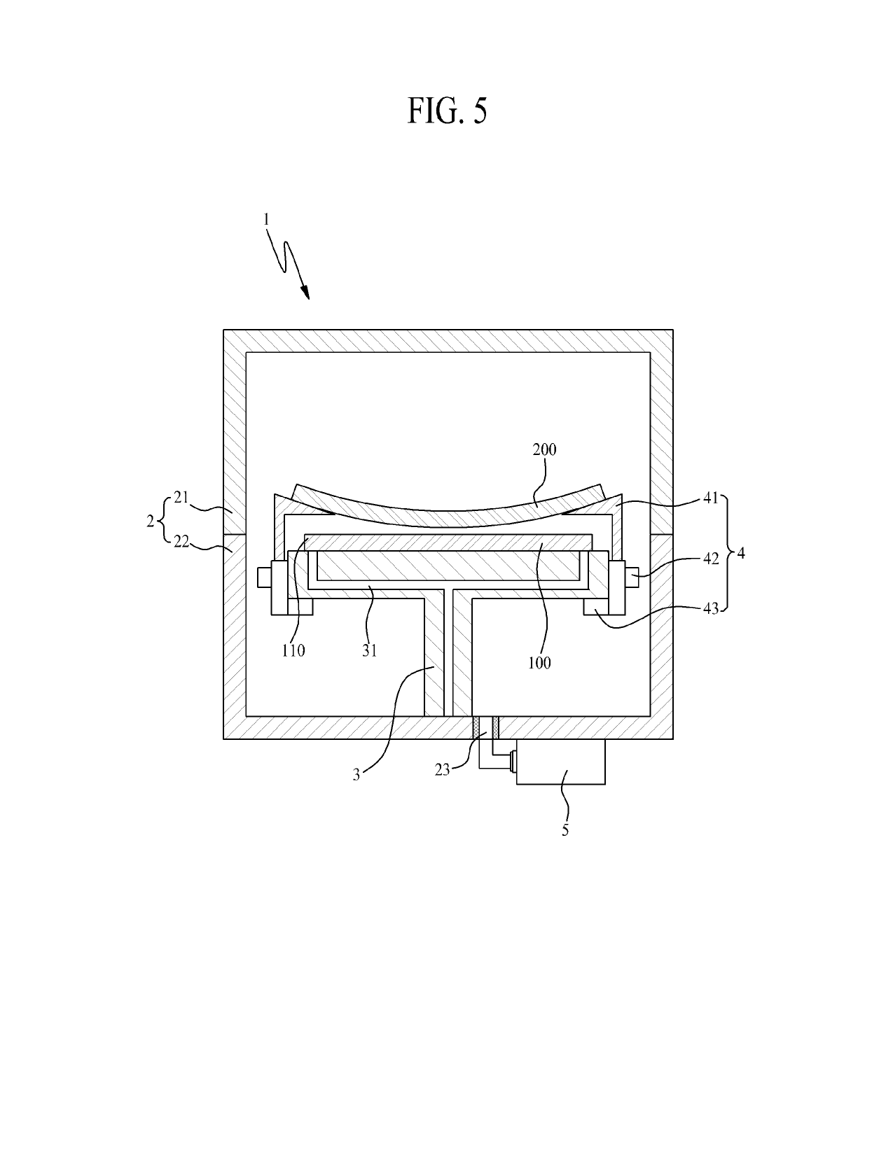

In FIG. 5, the chamber unit 2 includes a first chamber 21 and a second chamber 22. The first chamber 21 and the second chamber 22 can be moved to be brought into contact with each other and to be separated from each other. When the first chamber 21 and the second chamber 22 are separated from each other, the substrate 100 and the carrier substrate 200 can be loaded into the inside of the chamber unit 2 or unloaded from the chamber unit 2. When the first chamber 21 and the second chamber 22 are brought into contact with each other, the process for bonding the carrier substrate 200 to the substrate 100 can be performed in the chamber unit 2. The chamber unit 2 may further include an opening for loading an unloading the substrate 100 and the carrier substrate 200 from the chamber unit 2 using an additional transferring device.

Referring to FIG. 1, the first surface plate 3 supports the substrate 100 and is provided inside the chamber unit 2. The first surface plate 3 is positioned below the supporting unit 4. Accordingly, the substrate 100 is supported by the first surface plate 3 while being positioned below the carrier substrate 200.

In addition, the substrate 100 may be attached to the first surface plate 3 by a suction force. For this, the first surface plate 3 includes a vacuum hole 31 for supplying the suction force provided from a suction unit to the substrate 100. The suction unit suctions fluids (e.g., air) through the vacuum hole 31, whereby the substrate 100 supported by the first surface plate 3 is attached to the first surface plate 3. The vacuum hole 31 also transfers the suction force to a dummy area 110 (see FIG. 5) of the substrate 100.

In particular, the dummy area 110 corresponds to a non-display area in the display device. For example, the dummy area 110 may correspond to an area removed by a scribing process when manufacturing the display device. The dummy area 110 may also correspond to the edge of the substrate 100. Accordingly, even though the substrate 100 supported by the first surface plate 3 may be damaged by the suction force provided from the suction unit, the substrate-bonding apparatus 1 according to an embodiment of the present invention limits the damaged portion to the dummy area 100, thereby preventing the quality of display device from being deteriorated.

When the substrate 100 is attached to the first surface plate 3 and the carrier substrate 200 is supported by the supporting unit 4, a process for aligning the substrate 100 and the carrier substrate 200 can be performed. In particular, the process for aligning the substrate 100 and the carrier substrate 200 may be performed by moving at least one of the first surface plate 3 and the supporting unit 4. For example, a moving mechanism can be used for moving at least one of the first surface plate 3 and the supporting unit 4 so as to align the substrate 100 and the carrier substrate 200. The moving mechanism can move at least one of the first surface plate 3 and the supporting unit 4 by a cylinder method using a hydraulic cylinder or a pneumatic cylinder; a ball screw method using a motor and a ball screw; a gear method using a motor, a rack gear, and a pinion gear; a belt method using a motor, a pulley, and a belt; or a linear motor, for example.

Further, the first surface plate 3 may be an electrostatic chuck (ESC). In this instance, the substrate 100 can be attached to the first surface plate 3 using an electrostatic force. Also, the first surface plate 3 may include at least one electrode for attaching the substrate 100 to the first surface plate 3. The electrode may be provided in the first surface plate 3 and positioned in the dummy area 110 of the substrate 100. Thus, even though the substrate 100 supported by the first surface plate 3 may be damaged by the electrode, the substrate-bonding apparatus 1 according to an embodiment of the present invention limits the damaged portion to the dummy area 100, thereby preventing the quality of display device from being deteriorated.

In addition, the first surface plate 3 may also include at least one adhesive rubber. In this instance, the substrate 100 may be attached to the first surface plate 3 by an adhesive strength of the adhesive rubber. The adhesive rubber is provided in the first surface plate 3, and positioned in the dummy area 110 of the substrate 100. Thus, even though the substrate 100 supported by the first surface plate 3 may be damaged by the adhesive rubber, the substrate-bonding apparatus 1 according to an embodiment of the present invention limits the damaged portion to the dummy area 100, thereby preventing the quality of display device from being deteriorated.

Referring again to FIG. 1, the supporting unit 4 positioned inside the chamber unit 2 supports the carrier substrate 200. The supporting unit 4 supports the carrier substrate 200 so as to make the carrier substrate 200 positioned above the substrate 100 supported by the first surface plate 3. The supporting unit 4 may also be provided in the chamber unit 2 or the first surface plate 3, and can bring the carrier substrate 200 into contact with the substrate 100 supported by the first surface plate 3.

Further, the pressure-adjusting unit 5 is provided to the chamber unit 2. When the supporting unit 4 brings the carrier substrate 200 into contact with the substrate 100 supported by the first surface plate 3, the pressure-adjusting unit 5 lowers a pressure inside the chamber unit 2. Accordingly, the pressure-adjusting unit 5 discharges the gas remaining between the substrate 100 and the carrier substrate 200 from the gap between the substrate 100 and the carrier substrate 200, whereby the carrier substrate 200 is bonded to the substrate 100.

Further, the substrate 100 and the carrier substrate 200 may be bonded to each other using molecular binding. Also, to enhance bonding between the substrate 100 and the carrier substrate 200, the substrate 100 and the carrier substrate 200 may be bonded to each other after coating a sealant.

Thus, the substrate-bonding apparatus 1 according to an embodiment of the present invention bonds the carrier substrate 200 to the substrate 100 supported by the first surface plate 3 without applying the force toward the substrate 100 supported by the first surface plate 3. Accordingly, the substrate-bonding apparatus 1 prevents the substrate 100 from being spotted or deformed during the process for bonding the carrier substrate 200 to the substrate 100 supported by the first surface plate 3.

Also, the substrate-bonding apparatus 1 discharges the gas remaining between the substrate 100 and the carrier substrate 200 from the gap between the substrate 100 and the carrier substrate 200 when bonding the carrier substrate 200 to the substrate 100. Thus, the substrate-bonding apparatus 1 prevents bubbles from occurring between the substrate 100 and the carrier substrate 200, thereby improving the quality of slim display device.

In addition, the pressure-adjusting unit 5 suctions the gas remaining inside the chamber unit 2, thereby lowering the pressure inside the chamber unit 2. In more detail, the pressure-adjusting unit 5 lowers the pressure inside the chamber unit 2 so that a vacuum state is created inside the chamber unit 2. In this instance, the pressure-adjusting unit 5 may include a vacuum pump. In FIG. 1, the chamber unit 2 includes an exhaust hole 23. Accordingly, as the pressure-adjusting unit 5 is connected with the exhaust hole 23, the pressure inside the chamber unit 2 can b adjusted through the exhaust hole 23.

The pressure-adjusting unit 5 may also be provided outside the chamber unit 2, and spray the gas to the inside of the chamber unit 2, thereby raising the pressure inside the chamber unit 2. That is, the pressure-adjusting unit 5 raises the pressure inside the chamber unit 2 to an atmospheric pressure state. In this instance, the pressure-adjusting unit 5 may include a gas-spraying unit.

When substantially the entire surface of the carrier substrate 200 is brought into contact with the substrate 100, the pressure-adjusting unit 5 lowers the pressure inside the chamber unit 2 to the vacuum state. Before the substrate 100 and the carrier substrate 200 are brought into contact with each other, the pressure-adjusting unit 5 may first lower the pressure inside the chamber unit 2 to a first vacuum state. Accordingly, the amount of gas remaining between the substrate 100 and the carrier substrate 200 can be decreased when bringing the substrate 100 and the carrier substrate into contact with each other.

If the entire surface of the carrier substrate 200 is brought into contact with the substrate 100, the pressure-adjusting unit 5 can secondly lower the pressure inside the chamber unit 2 to a second vacuum state. Further, a vacuum level of the second vacuum state is higher than that of the first vacuum state. Thus, the pressure-adjusting unit 5 completely discharges the gas remaining between the substrate 100 and the carrier substrate 200 from the gap between the substrate 100 and the carrier substrate 200, thereby bonding the carrier substrate 200 to the substrate 100 using molecular binding without adhesive.

Further, the supporting unit 4 may be implemented in various embodiments so as to bring the carrier substrate 200 into contact with the substrate 100. Hereinafter, the supporting unit 4 according to the various embodiments of the present invention will be described in detail with reference to the accompanying drawings.

### First Embodiment

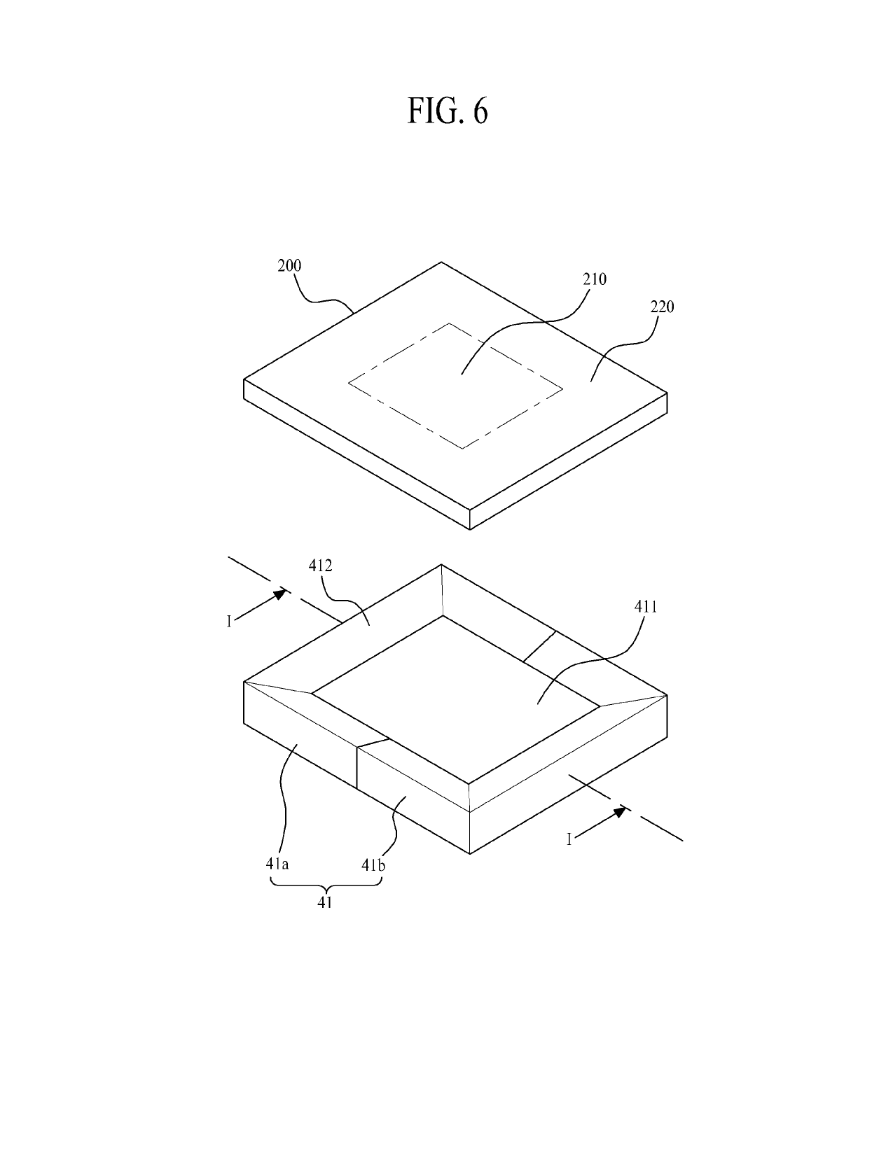

Referring to FIGS. 5 to 9, the supporting unit 4 according to the first embodiment of the present invention first brings a first area 210 (see FIG. 6) of the carrier substrate 200 into contact with the substrate 100, and then secondly brings a second area 220 (see FIG. 6) of the carrier substrate 200 into contact with the substrate 100. The first area 210 is a predetermined portion of the carrier substrate 200. That is, the supporting unit 4 according to the first embodiment of the present invention brings the predetermined portion of the carrier substrate 200 into contact with the substrate 100, and then brings the remaining portions of the carrier substrate 200 into contact with the substrate 100. Thus, the substrate-bonding apparatus 1 according to an embodiment of the present invention achieves the following efficiency.

First, if the entire surface of the carrier substrate 200 is brought into contact with the substrate 100 at the same time so as to bond the carrier substrate 200 to the substrate 100, bubbles can occur between the substrate 100 and the carrier substrate 200. The bubbles tend to cause spots on the substrate 100 or the partial deformation in the substrate 100, thereby deteriorating the quality of the substrate 100.

In contrast, the supporting unit 4 of the substrate-bonding apparatus 1 according to an embodiment of the present invention first brings the first area 210 of the carrier substrate 200 into contact with the substrate 100, and then secondly brings the second area 220 of the carrier substrate 200 into contact with the substrate 100. Accordingly, after the first area 210 of the carrier substrate 200 is brought into first contact with the substrate 100, the second area 220 of the carrier substrate 200 is gradually brought into contact with the substrate 100 while discharging the gas such as air remaining between the substrate 100 and the carrier substrate 200. Thus, the substrate-bonding apparatus 1 according to an embodiment of the present invention prevents bubbles from occurring between the substrate 100 and the carrier substrate 200 when bonding the carrier substrate 200 to the substrate 100, thereby improving the quality of slim display device.

In addition, the first area 210 is a predetermined portion of the carrier substrate 200 and may be the central portion or edge portion of the carrier substrate 200. That is, when the first area 210 contacts the substrate 100 before the second area 220 contacts the substrate 100, any portion of the carrier substrate 200 can be determined as the first area 210. For example, as shown in FIG. 6, the first area 210 is the central portion of the carrier substrate 200, and the second area 220 is the edge portion of the carrier substrate 200. That is, the second area 220 is formed in a shape surrounding the first area 210.

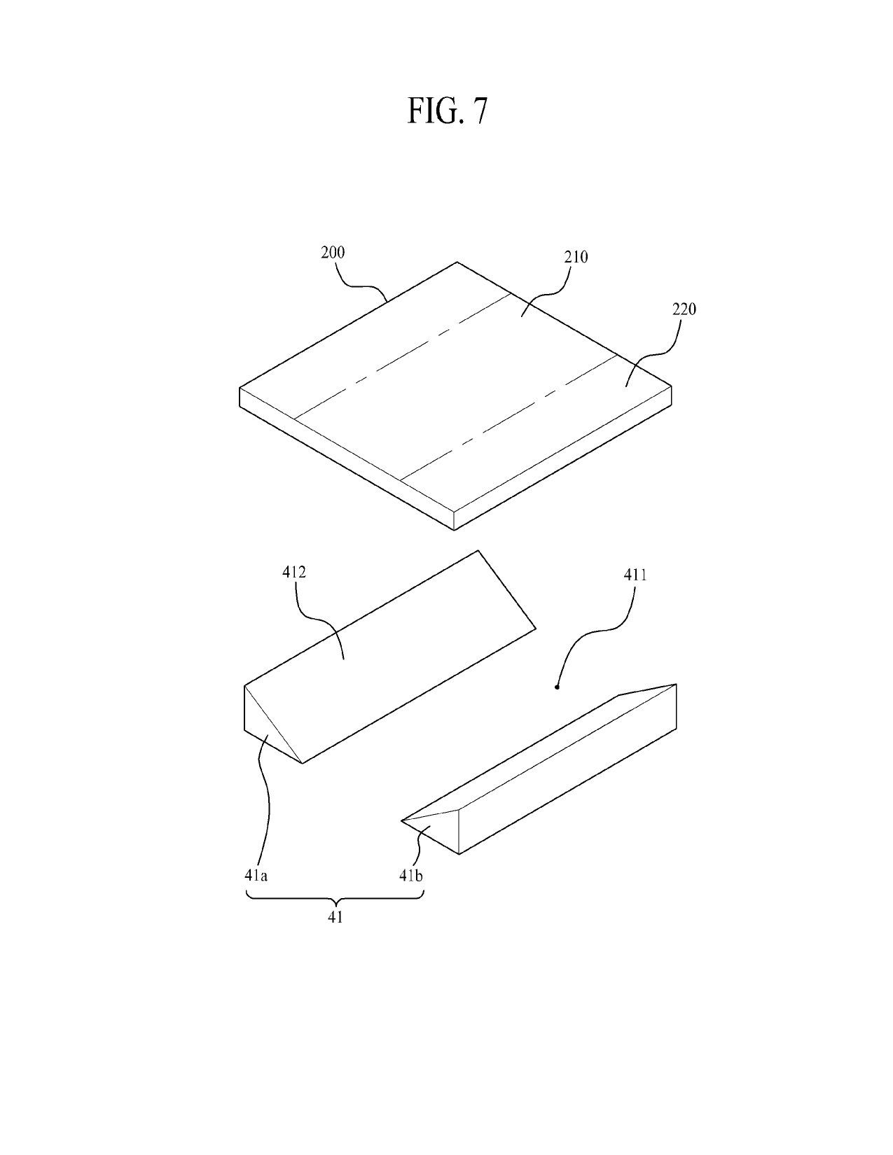

As shown in FIG. 7, the first area 210 may be the central portion with respect to any one direction of a long side and short side of the carrier substrate 200, and the second area 220 may be the edge portion in the circumstance of the first area 210. Further, the second area 220 may be the central portion with respect to any one direction of a long side and short side of the carrier substrate 200, and the first area 210 may be the edge portion in the circumstance of the second area 220.

In FIGS. 6 and 7, the first area 210 is formed in a rectangle shape, but this is just one embodiment. That is, the first area 210 may be formed in any shape suitable for contacting the first area 210 with the substrate 100 before contacting the second area 220 with the substrate, for example, a circle-shaped first area, elliptical-shaped first area, etc.

Referring to FIGS. 5 to 7, the supporting unit 4 includes a supporting device or supporting member 41 for supporting the carrier substrate 200. As discussed above, the supporting device 41 is provided inside the chamber unit 2 and supports the carrier substrate 200 so as to position the carrier substrate 200 above the substrate 100 supported by the first surface plate 3. The supporting device 41 may also be provided in the first surface plate 3, provided in the chamber unit 2, etc. If the supporting device 41 is provided in the first surface plate 3, one end of the supporting device 41 is connected with the first surface plate 3, and the other end of the supporting device 41 is positioned to be higher than the substrate 100 supported by the first surface plate 3. Accordingly, the supporting device 41 can support the carrier substrate 200 so as to position the carrier substrate 200 above the substrate 100.

In FIG. 6, the supporting device 41 includes a passing hole or hollow portion or through-hole 411 for protruding the first area 210 toward the substrate 100 supported by the first surface plate 3. The hollow portion 411 can be formed by penetrating the supporting device 41 and is positioned to correspond with the first area 210 of the carrier substrate 200. Because the first area 210 of the carrier substrate 200 sags due to its own weight, the first area 210 of the carrier substrate 200 protrudes toward the substrate 100, which is supported by the first surface plate 3, through the hollow portion 411.

In this example, the entire or partial portion of the second area 220 is maintained while being supported by the supporting device 41. Accordingly, as the first area 210 protrudes toward the substrate 100 through the hollow portion 411, the first area 210 is positioned closer to the substrate 100 in comparison with the second area 220. Therefore, the first area 210 is first brought into contact with the substrate 100, and the second area 220 is then brought into second contact with the substrate 100. Thus, the substrate-bonding apparatus 1 according to an embodiment of the present invention produces the following efficiency.

The substrate-bonding apparatus 1 according to an embodiment of the present invention first brings the first area 210 of the carrier substrate 200 into contact with the substrate 100 the using supporting device 41. Accordingly, the first area 210 of the carrier substrate 200 is first brought into contact with the substrate 100, and then the second area 220 of the carrier substrate 200 is gradually brought into contact with the substrate 100 by discharging the gas such as air remaining between the substrate 100 and the carrier substrate 200. Thus, the substrate-bonding apparatus 1 prevents bubbles from occurring between the substrate 100 and the carrier substrate 200 when bonding the carrier substrate 200 to the substrate 100, thereby improving the quality of slim display device. A step-by-step discharging gas method is also used as discussed above.

Next, a method in which the first area 210 of the carrier substrate 200 is positioned closer to the substrate 100 than the second area 220 is shown. This method uses a structure for pushing the first area 210 toward the substrate 100 supported by the first surface plate 3 such as a pushing pin or diaphragm. However, this method may cause partial spots or deformation in the substrate 100, because the structure pushes the substrate 100 in contact with the first area 210. Also, gas can be sprayed toward the first area 210 so that the first area 210 of the carrier substrate 200 is positioned closer to the substrate 100 than the second area 220. This method also tends to create partial spots or deformation in the substrate 100, because the jetting force affects the substrate 100 in contact with the carrier substrate 200 as well as the carrier substrate 200.

However, the supporting unit 4 according to the first embodiment of the present invention uses the first area 210 sagging through the hollow portion 411 due to the weight of the carrier substrate 200, whereby the first area 210 is first brought into contact with the substrate 100 before the second area 220. That is, the substrate-bonding apparatus 1 makes the first area 210 be brought into contact with the substrate 100 before the second area 220 is brought into contact with the substrate 100, without using the pushing pin, diaphragm, or jetting force. Thus, the substrate-bonding apparatus 1 prevents the substrate 100 from being spotted or deformed when bonding the carrier substrate 200 to the substrate 100, thereby improving the quality of slim display device.

Thirdly, the substrate-bonding apparatus 1 uses the supporting device 41, and thus only uses one surface plate when bonding the carrier substrate 200 to the substrate 100. Thus, in comparison with using multiple surface plates, the number of surface plates is decreased in the present invention, thereby decreasing the manufacturing cost for bonding the carrier substrate 200 to the substrate 100.

As shown in FIG. 6, the supporting device 41 includes the hollow portion 411 formed in a rectangular plate shape. However, the supporting device 41 may also be formed in a rectangular ring shape. Further, the hollow portion 411 is positioned to correspond with the first area 210. For example, if the first area 210 corresponds to the central portion of the carrier substrate 200, the hollow portion 411 penetrates through the central portion of the supporting device 41.

In this instance, the supporting device 41 may support the entire or partial portion of the second area 220. In FIG. 6, the hollow portion 411 is formed in the rectangular ring shape, but other shapes are possible such that the first area 210 is positioned closer to the substrate 100 than the second area 220. For example, the hollow portion 411 can be a circle shape or elliptical shape.

As shown in FIG. 7, the supporting device 41 may include a first supporting member 41a and a second supporting member 41b. The first supporting member 41a and the second supporting member 41b may be separated from each other. Accordingly, as the first supporting member 41a and the second supporting member 41b are separated from each other, the hollow portion 411 can be formed between first supporting member 41a and the second supporting member 41b. Further, the first supporting member 41a and the second supporting member 41b may be separated from each other with respect to any one direction of a long side and short side of the carrier substrate 200. The first supporting member 41a and the second supporting member 41b may also be separated from each other with respect to a diagonal direction of the carrier substrate 200.

Referring to FIGS. 5 to 7, the supporting device 41 includes a diagonal member 412 whose thickness is gradually decreased toward the hollow portion 411. The diagonal member 412 is brought into contact with the carrier substrate 200. In more detail, the diagonal member 412 is provided so its surface in contact with the carrier substrate 200 slopes down from its end toward the hollow portion 411, which makes the first area 210 close to the first surface plate 3.

As the carrier substrate 200 is sagging due to its own weight, the carrier substrate 200 is brought into contact with the diagonal member 412. Thus, the first area 210 of the carrier substrate 200 protrudes toward the substrate 100 supported by the first surface plate 3 through the hollow portion 411. Further, the diagonal member 412 makes the carrier substrate 200 bend by its own weight, thereby preventing the carrier substrate 200 from being damaged when the first area 210 protrudes through the hollow portion 411.

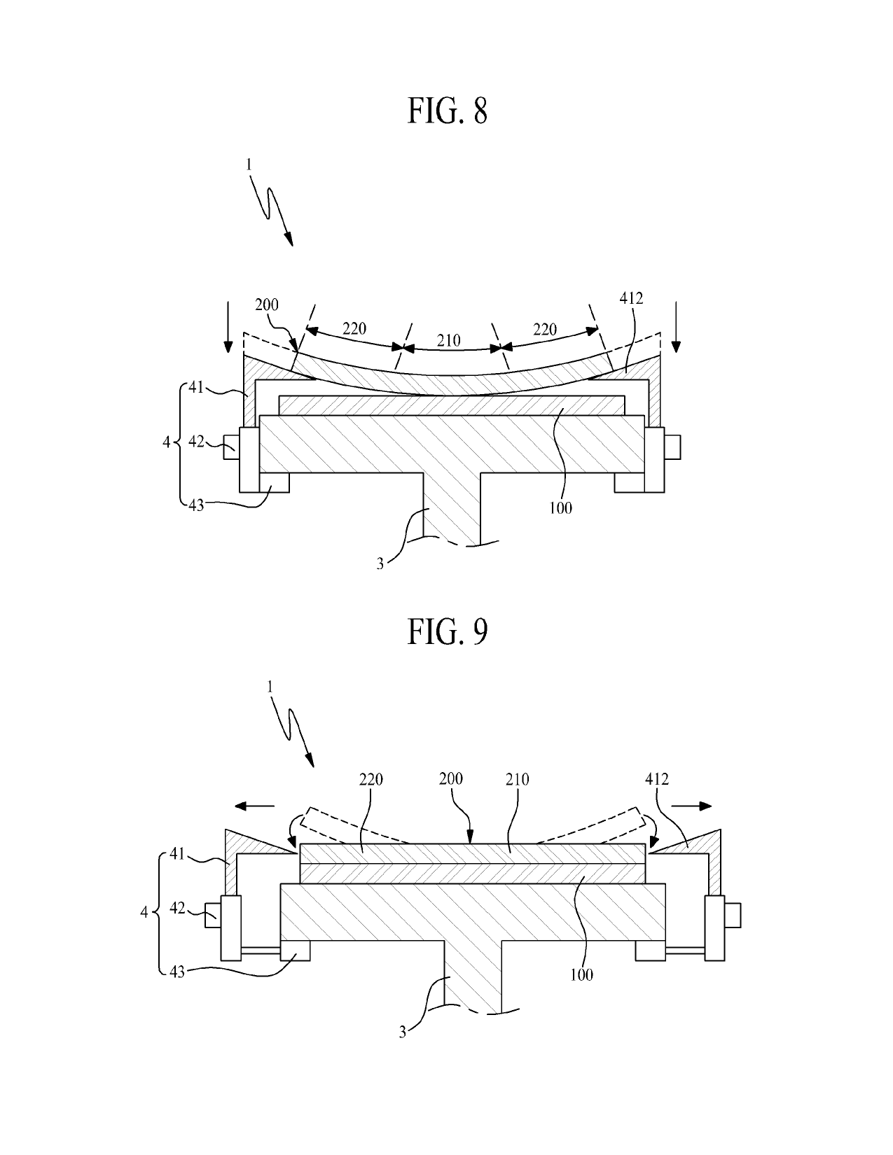

Referring to FIGS. 8 and 9, the supporting unit 4 according to the first embodiment of the present invention includes an elevating unit 42 for elevating the supporting device 41, and a moving unit 43 for moving the supporting device 41. FIGS. 8 and 9 are cross sectional views of the substrate-bonding device 1 along I-I of FIG. 6.

When the first area 210 of the carrier substrate 200 protrudes toward the substrate 100 through the hollow portion 411, the elevating unit 42 lowers the supporting device 41. Accordingly, as shown in FIG. 8, the first area 210 of the carrier substrate 200 is first brought into contact with the substrate 100 before the second area 220 is brought into contact with the substrate 100.

After aligning the substrate 100 and the carrier substrate 200 when the carrier substrate 200 is supported by the supporting device 41, the elevating unit 42 can lower the supporting device 41. The elevating unit 42 may be combined with the first surface plate 3. Further, the elevating unit 42 can lower or elevate the supporting device 41 using a hydraulic cylinder or a pneumatic cylinder; a ball screw method using a motor and a ball screw; a gear method using a motor, a rack gear, and a pinion gear; a belt method using a motor, a pulley, and a belt; or a linear motor, for example. The elevating unit 42 may also be combined with the chamber unit 2. The supporting unit 4 can also include a plurality of elevating units 42.

Referring to FIGS. 6, 8 and 9, when the first area 210 of the carrier substrate 200 is brought into contact with the substrate 100 supported by the first surface plate 3, the moving unit 43 moves the supporting device 41 away from the space between the substrate 100 and the carrier substrate 200. Accordingly, the second area 220 of the carrier substrate 200 is gradually brought into contact with the substrate 100 while discharging the gas such as air remaining between the substrate 100 and the carrier substrate 200. Thus, the substrate-bonding apparatus 1 prevents bubbles from occurring between the substrate 100 and the carrier substrate 200 when bonding the carrier substrate 200 to the substrate 100, thereby improving the quality of slim display device.

In addition, the moving unit 43 may be combined with the first surface plate 3. The moving unit 43 may also move the supporting device 41 by a cylinder method using a hydraulic cylinder or a pneumatic cylinder; a ball screw method using a motor and a ball screw; a gear method using a motor, a rack gear, and a pinion gear; a belt method using a motor, a pulley, and a belt; or a linear motor. Further, the moving unit 43 may be combined with the chamber unit 2. The supporting unit 4 may also include a plurality of moving units 43. Accordingly, as the elevating unit 42 is combined with the moving unit 43, the elevating unit 42 may be provided in the first surface plate 3 or chamber unit 2.

In order to decrease the time consumed to make the supporting device 41 be apart from the space between the substrate 100 and the carrier substrate 200, the supporting device 41 may include the first supporting member 41a (see FIG. 6) and the second supporting member 41b (see FIG. 6). In this instance, the moving unit 43 moves the first supporting member 41a and the second supporting member 41b to be apart from each other.

In order to make the first supporting member 41a and the second supporting member 41b be apart from the space between the substrate 100 and the carrier substrate 200, the moving unit 43 may decrease the time and distance for moving the first supporting member 41a and the second supporting member 41b. Thus, the substrate-bonding apparatus 1 decreases the time used to bring the second area 220 into contact with the substrate 100, thereby decreasing the time used to bond the carrier substrate 200 to the substrate 100. The supporting unit 4 may also include a plurality of moving units 43 so as to move the first supporting member 41a and the second supporting member 41b to be close to each other or to be apart from each other.

Assuming the supporting device 41 includes the diagonal member 412, as the moving unit 43 moves the first supporting member 41a and the second supporting member 41b to be apart from each other, the second area 220 of the carrier substrate 200 is gradually brought into contact with the substrate 100 owing to the diagonal member 412. Accordingly, the carrier substrate 200 is gradually brought into contact with the substrate 100 while discharging the gas such as air remaining between the substrate 100 and the carrier substrate 200. Also, the diagonal member 412 makes the second area 220 gradually be brought into contact with the substrate 100. Thus, it is possible to prevent the substrate 100 from being damaged by an impact occurring when bringing the second area 220 into contact with the substrate 100, thereby improving the quality of slim display device.

Further, the supporting device 41 may be formed of a material which is capable of preventing the carrier substrate 200 from being damaged by a friction when moving the supporting device 41 away from the space between the substrate 100 and the carrier substrate 200 using the moving unit 43. For example, the supporting device 41 may be formed of at least one among Teflon, Ceramic, and Polyetherether Ketone (PEEK).

When the first area 210 of the carrier substrate 200 is brought into contact with the substrate 100 by the supporting device 41, the pressure-adjusting unit 5 first lowers the pressure inside the chamber unit 2 so as to make a first vacuum state inside the chamber unit 2. When the second area 220 of the carrier substrate 200 is brought into contact with the substrate 100 by the supporting device 41, the pressure-adjusting unit 5 secondly lower the pressure inside the chamber unit 2 so as to make a second vacuum sate inside the chamber unit 2. Accordingly, the substrate-bonding apparatus 1 completely discharges the gas remaining between the substrate 100 and the carrier substrate 200 from the space between the substrate 100 and the carrier substrate 200, thereby bonding the carrier substrate 200 and the substrate 100 to each other. The second vacuum state is higher than the first vacuum state as discussed above.

### Second Embodiment

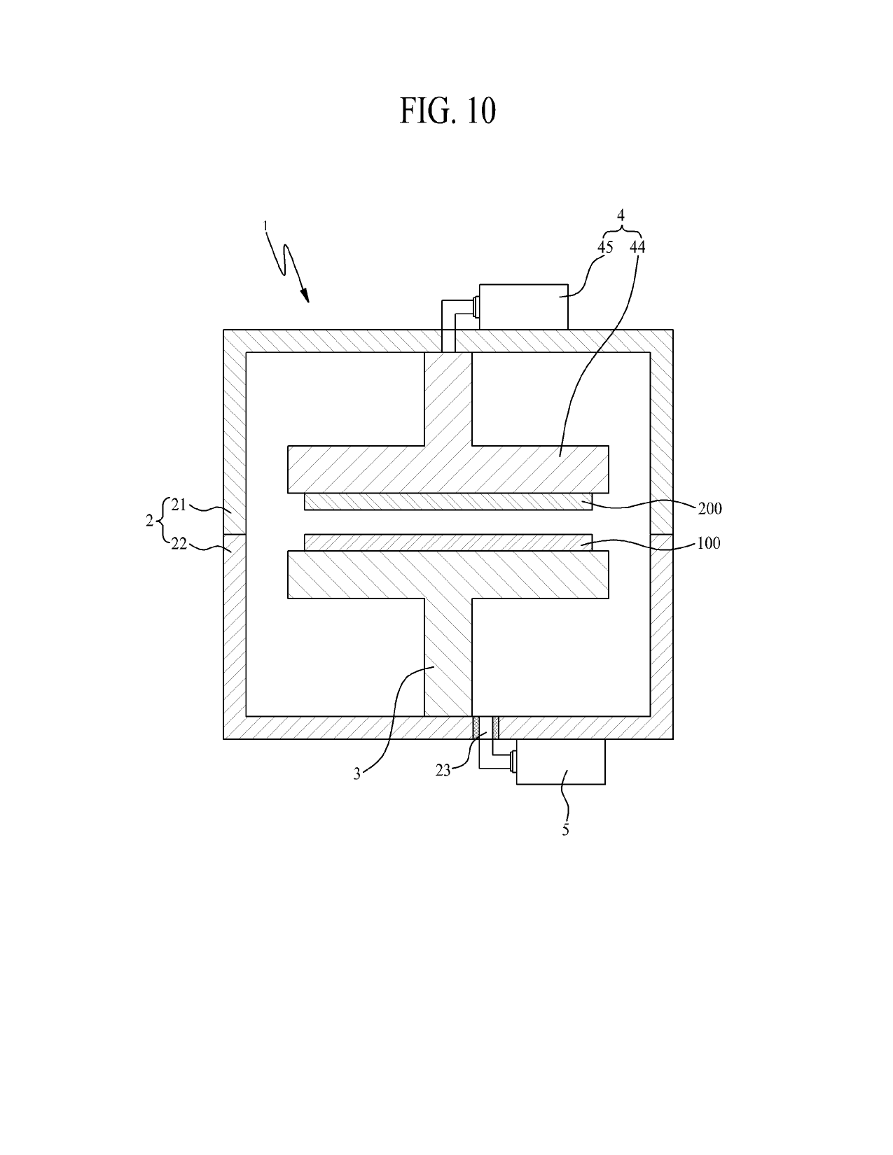

Referring to FIGS. 10 to 12, the supporting unit 4 according to the second embodiment of the present invention includes a second surface plate 44 to which the carrier substrate 200 is attached, and a suction unit 45 for supplying a suction force so as to attach the carrier substrate 200 to the second surface plate 44.

The second surface plate 44 is provided inside the chamber unit 2 and is positioned above the first surface plate 3 inside the chamber unit 2. The carrier substrate 200 is attached to the second surface plate 44, whereby the carrier substrate 200 is positioned above the substrate 100 supported by the first surface plate 3.

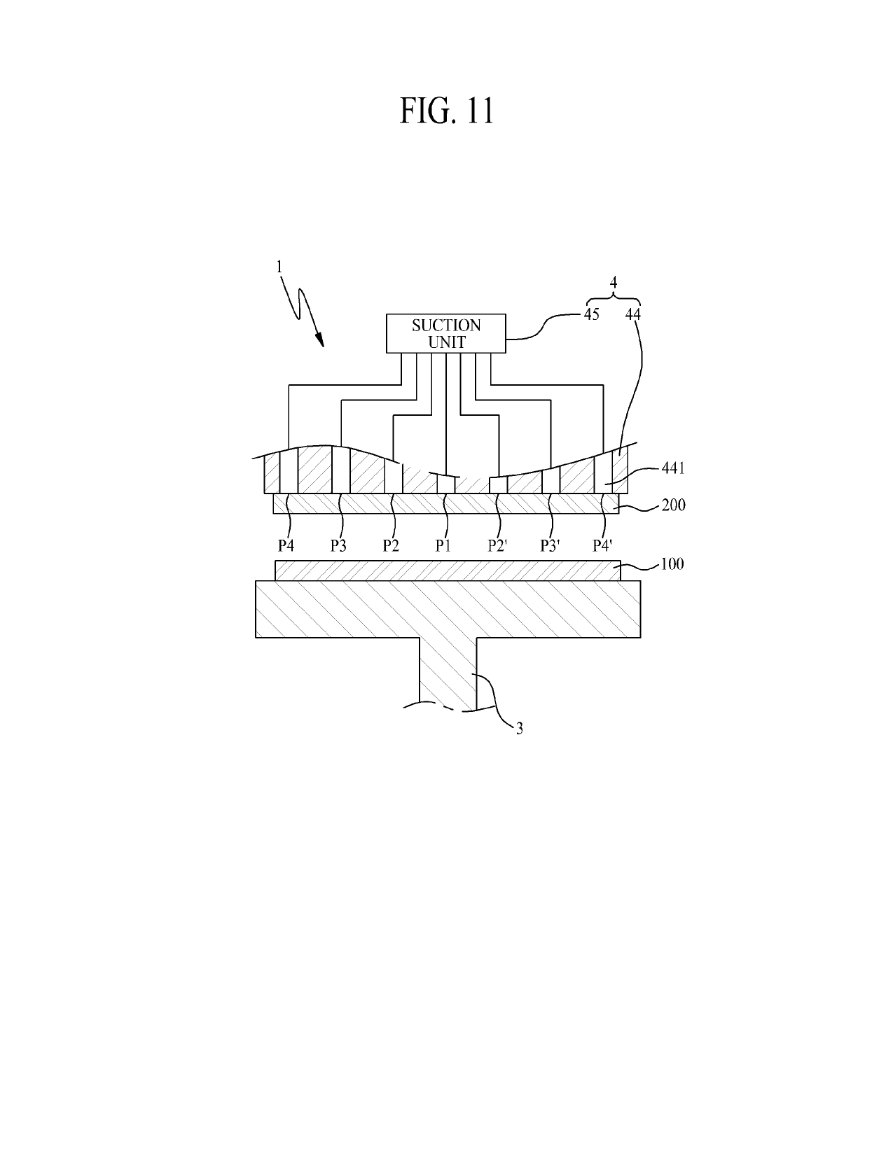

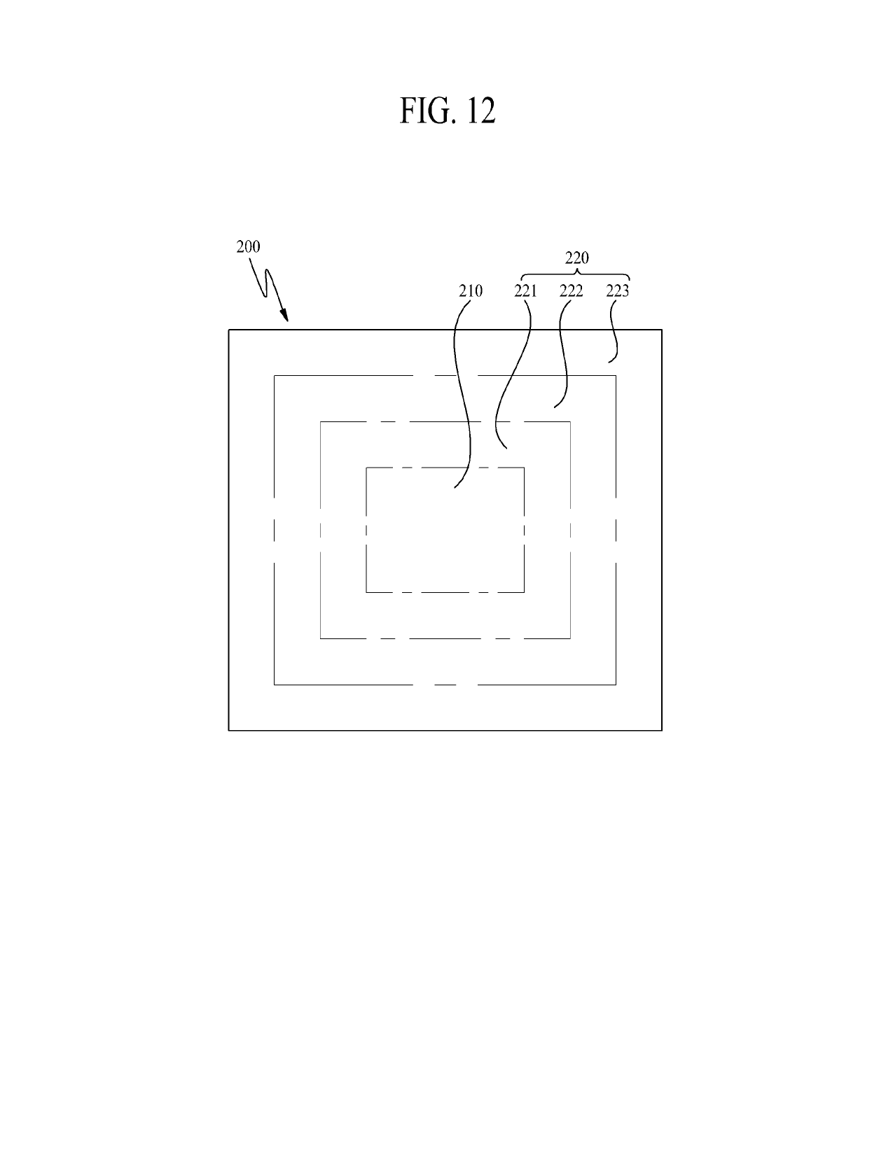

Further, the second surface plate 44 includes a plurality of suction holes 441 (see FIG. 11) to transfer the suction force to the carrier substrate 200. The suction holes 441 are formed at fixed intervals, and provided in the second surface plate 44. The plurality of suction holes 441 may be positioned to correspond with the first area 210 (see FIG. 12) of the carrier substrate 200. The plurality of suction holes 441 may also be positioned to correspond with the second area 220 (see FIG. 12) of the carrier substrate 200.

Referring to FIGS. 10 to 14, the suction unit 45 is combined with the chamber unit 2, wherein the suction unit 45 is connected with the suction holes 441 (see FIG. 11). When the suction unit 45 is combined with the chamber unit 2, the suction unit 45 may be positioned outside the chamber unit 2. Further, while being combined with the second surface plate 44, the suction unit 45 may be connected with the suction holes 441. The suction unit 45 supplies the suction force so as to attach the carrier substrate 200 to the second surface plate 44.

In addition, the suction unit 45 adjusts the suction force so that the pressure between the carrier substrate 200 and the second surface plate 44 is gradually increased from the first area 210 toward the second area 220 (see FIG. 12). Accordingly, the pressure is adjusted so the pressure (P1, see FIG. 11) between the first area 210 of the carrier substrate 200 and the second surface plate 44 is higher than the pressure (P2, P2′, P3, P′3, P4 and P′4, see FIG. 11) between the second area 220 of the carrier substrate 200 and the second surface plate 44.

Also, the pressure (P2, P2′, P3, P′3, P4 and P′4, see FIG. 11) between the second area 220 of the carrier substrate 200 and the second surface plate 44 is gradually decreased from the first area 210 toward the second area 220. That is, a level of the pressure between the carrier substrate 200 and the second surface plate 44 is adjusted in the order of P1>(P2=P2′)>(P3=P3′)>(P4=P4′) using suction unit 45. If it is converted into a vacuum level, P1<(P2=P2′)<(P3=P3′)<(P4=P4′).

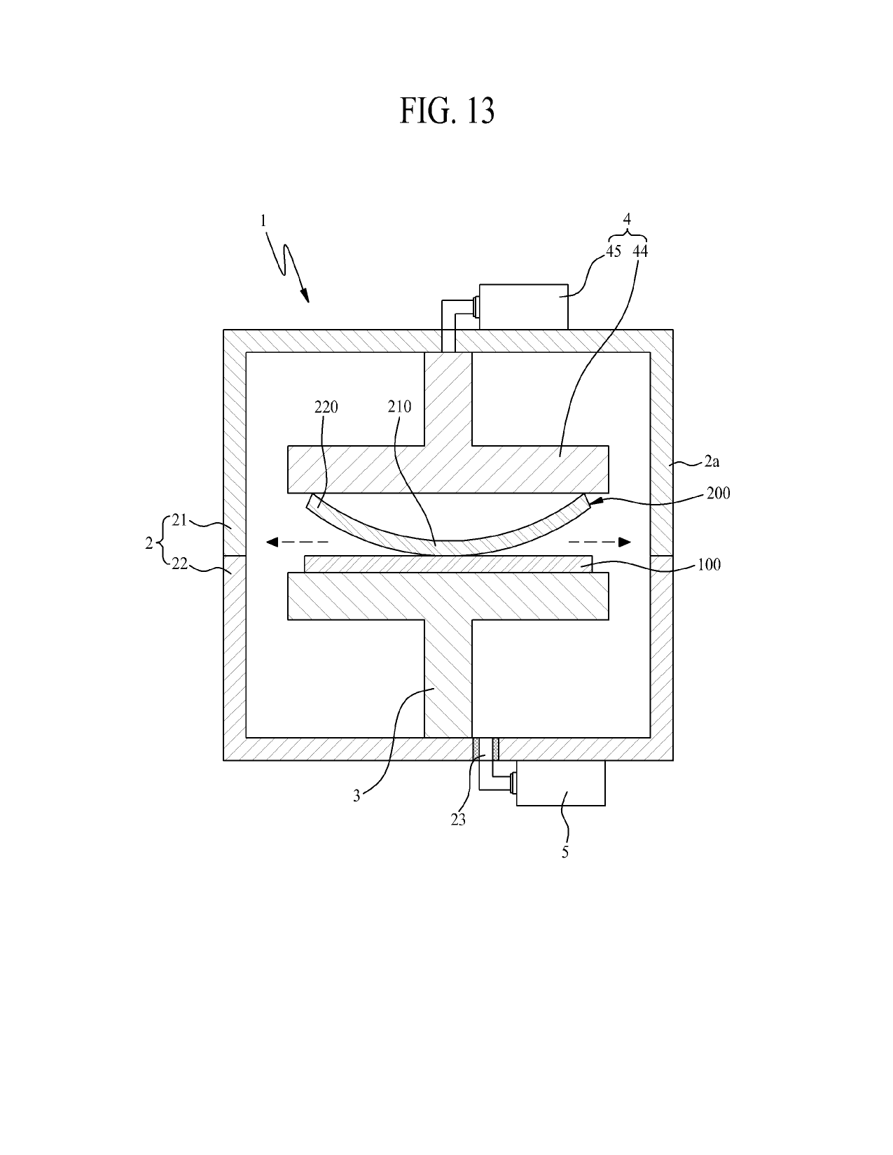

Under this condition, if the pressure-adjusting unit 5 (see FIG. 10) gradually lowers the pressure inside the chamber unit 2, as shown in FIG. 13, the separation of the first area 210 from the second surface plate 44 precedes the separation of the second area 220 from the second surface plate 44. According as the pressure inside the chamber unit 2 is gradually lowered, the portion with the higher pressure between the carrier substrate 200 and the second surface plate 44 is first separated from the second surface plate 44.

When the pressure inside the chamber unit 2 becomes lower than the pressure between the first area 210 and the second surface plate 44, the first area 210 of the carrier substrate 200 is first separated from the second surface plate 44, whereby the first area 210 is first brought into contact with the substrate 100. After completing the process for aligning the substrate 100 and the carrier substrate 200, the pressure-adjusting unit 5 may gradually lower the pressure inside the chamber unit 2.

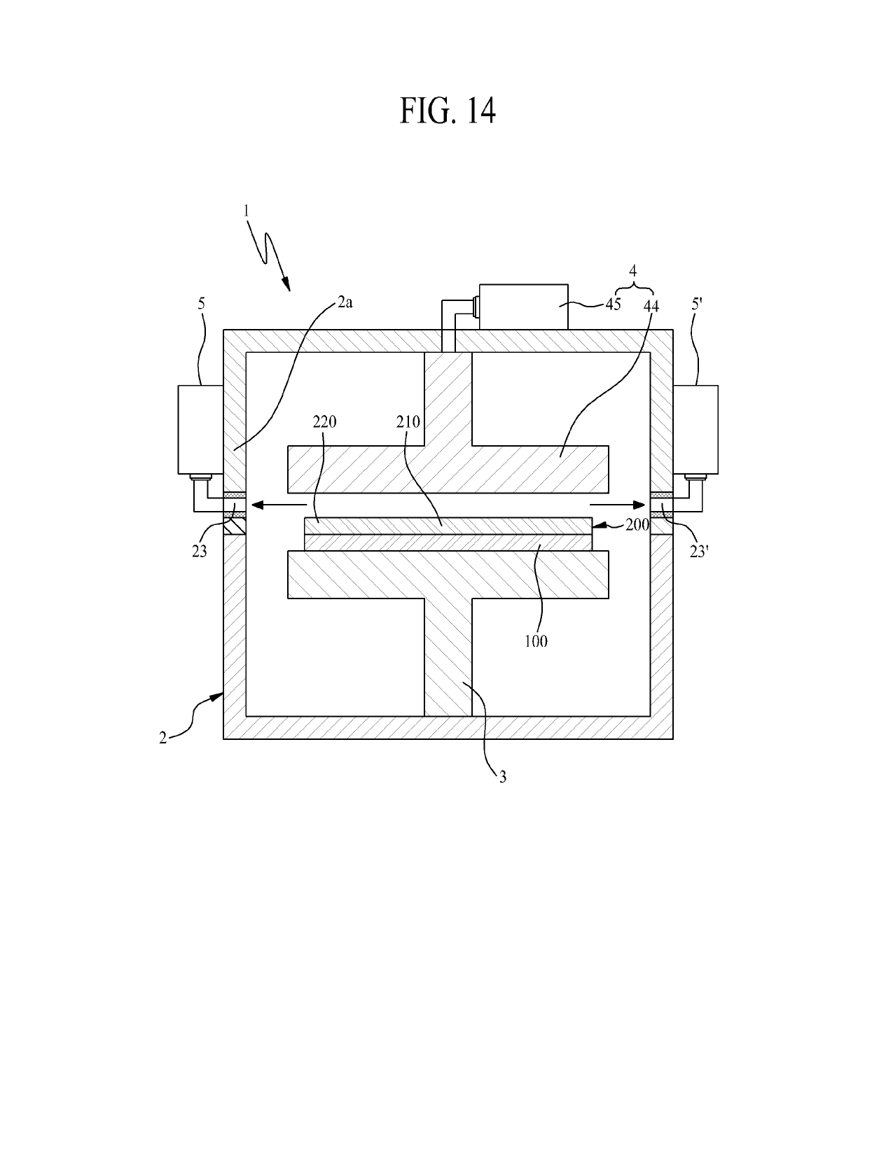

When the pressure-adjusting unit 5 makes a larger gradual decrease of the pressure inside the chamber unit 2, as shown in FIG. 14, the second area 220 is separated from the second surface plate 44. When the pressure inside the chamber unit 2 becomes lower than the pressure between the second area 220 and the second surface plate 44, the second area 220 is brought into contact with the substrate 100. As the pressure between the carrier substrate 200 and the second surface plate 44 is adjusted to be gradually lowered from the first area 210 to the second area 220, the carrier substrate 200 is sequentially separated in the direction from the first area 210 to the second area 220 according to the gradual decrease of the pressure inside the chamber unit 2, and is then gradually brought into contact with the substrate 100.

Accordingly, the substrate-bonding apparatus 1 according to an embodiment of the present invention achieves the following efficiency. That is, the substrate-bonding apparatus 1 first brings the first area 210 of the carrier substrate 200 into contact with the substrate 100 using the supporting unit 4 of the second embodiment of the present invention. Accordingly, after the first area 210 of the carrier substrate 200 is first brought into contact with the substrate 100, the second area 220 of the carrier substrate 200 is gradually brought into contact with the substrate 100 while discharging the gas remaining between the carrier substrate 200 and the substrate 100.

Thus, the substrate-bonding apparatus 1 according to an embodiment of the present invention prevents bubbles from occurring between the substrate 100 and the carrier substrate 200 when bonding the carrier substrate 200 to the substrate 100, thereby improving the quality of slim display device.

Secondly, the substrate-bonding apparatus 1 first brings the first area 210 into contact with the substrate 100, and then brings the second area 220 into contact with the substrate 100, without using a pushing pin, diaphragm, or jetting force. Thus, the substrate-bonding apparatus 1 prevents the substrate 100 from being spotted or deformed when bringing the carrier substrate 200 into contact with the substrate 100, thereby improving the quality of slim display device. An adhesive layer is also not used.

Referring to FIGS. 11, 12 and 15, the suction unit 45 differently adjusts the suction force for each section of the suction holes 441 of the second surface plate 44 so that the pressure between the carrier substrate 200 and the second surface plate 44 is gradually increased from the first area 210 to the second area 220. Further, the suction unit 45 may differently adjust the suction force for the respective suction holes 441 according to each section with size and shape corresponding to each of the first area 210 and the second area 220.

For example, as shown in FIG. 12, the first area 210 is positioned in the central portion of the carrier substrate 200, and the second area 220 is positioned in the edge portion surrounding the first area 210. In this instance, the section supplied with the suction force corresponding to the first area 210 using the suction unit 45 (see FIG. 11) may be the central portion of the second surface plate 44. The section supplied with the suction force corresponding to the second area 220 using the suction unit 45 may be the edge portion of the second surface plate 44.

Further, as shown in FIG. 12, the second area 220 may include a plurality of subareas 221, 222 and 223 which are rectangle-shaped rings positioned in the edge portion surrounding the first area 210. In this instance, the suction unit 45 differently adjusts the suction force for the respective suction holes 441 according to each section corresponding to each of the subareas 221, 222 and 223. The first area 210 may also include a plurality of subareas. In this instance, the suction unit 45 may differently adjust the suction force for the respective suction holes 441 according to each section corresponding to each of the subareas of the first area 210.

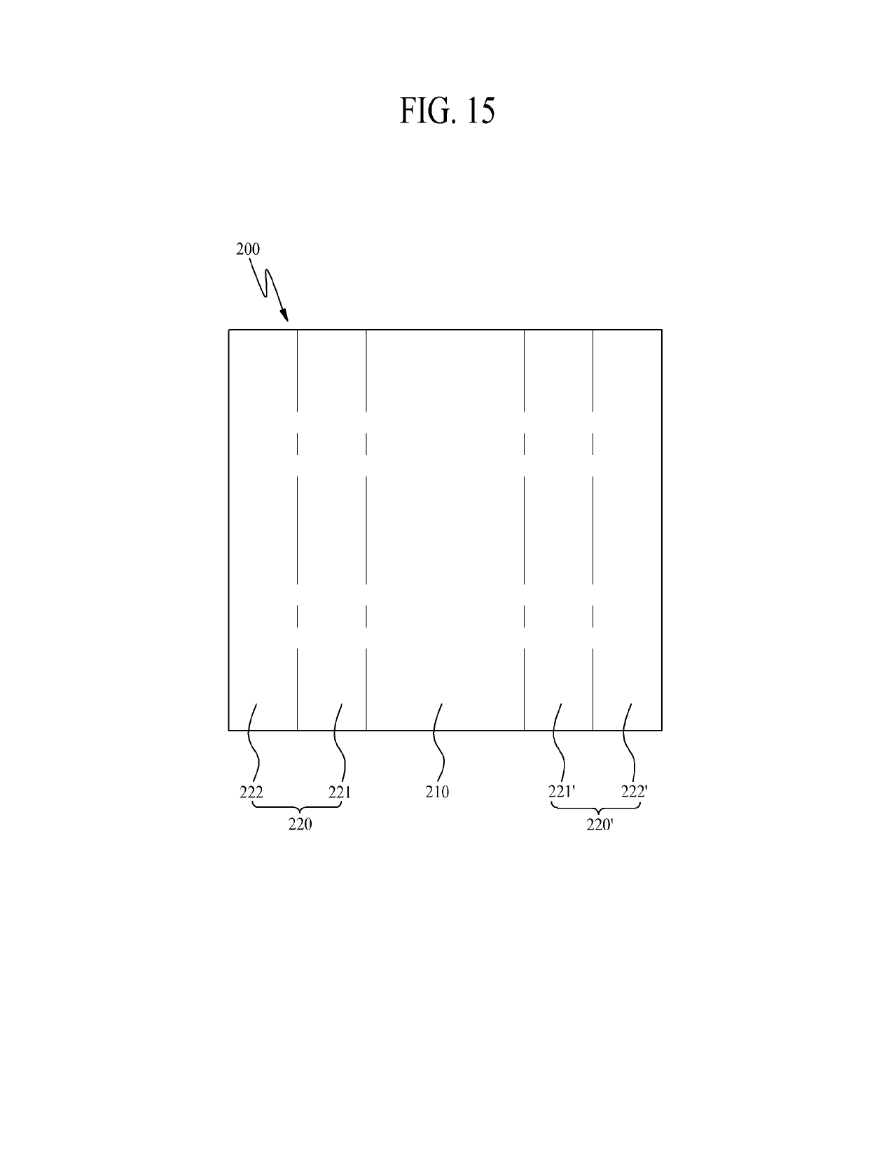

For example, as shown in FIG. 15, the first area 210 may be the central portion with respect to any one direction of a long side and short side of the carrier substrate 200, and the second area 220 and 220′ may be the edge portion in the circumstance of the first area 210. In this instance, the section supplied with the suction force corresponding to the first area 210 using suction unit 45 may be the central portion of the second surface plate 44. The section supplied with the suction force corresponding to the second area 220 and 220′ using suction unit 45 may be the edge portion of the second surface plate 44 in the circumference of the first area 210.

The second area 220 and 220′ may include the plurality of subareas 221, 221′, 222 and 222′. In this instance, the suction unit 45 may differently adjust the suction force for the respective suction holes 441 according to each section corresponding to each of the subareas 221, 221′, 222 and 222′. In addition, the first area 210 may include the plurality of subareas. In this instance, the suction unit 45 may differently adjust the suction force for the respective suction holes 441 according to each section corresponding to each of the subareas of the first area 210.

Referring to FIG. 11, the supporting unit 4 according to the second embodiment of the present invention may include a plurality of suction units 45 so as to differently adjust the suction force for the respective suction holes 441 of the second surface plate 44 according to each section. In this instance, the suction units 45 may be respectively connected with the suction holes 441 positioned in the different sections. The supporting unit 4 may also include the suction units 45 whose number corresponds to the number of sections. When each of the suction holes 441 corresponding to the respective sections reaches a preset level of pressure, the suction for the respective suction holes 441 are individually stopped by the suction units 45, whereby the pressure between the carrier substrate 200 and the second surface plate 44 is adjusted to be gradually increased from the first area 210 to the second area 220.

Referring to FIGS. 13 and 14, the pressure-adjusting unit 4 may lower the pressure inside the chamber unit 2 using the exhaust hole 23 provided in the chamber unit 2. As shown in FIG. 13, the exhaust hole 23 may be formed at the bottom of the chamber unit 2. Accordingly, the pressure-adjusting unit 5 suctions the gas through the bottom of the chamber unit 2, thereby lowering the pressure inside the chamber unit 2.

As shown in FIG. 14, the pressure-adjusting unit 5 may adjust the pressure inside the chamber unit 2 using exhaust holes 23 and 23′ provided at the sidewall 2a of the chamber unit 2. In this instance, the substrate-bonding apparatus 1 may include a plurality of pressure-adjusting units 5 and 5′ respectively connected with the exhaust holes 23 and 23′. In addition, the substrate-bonding apparatus 1 may include a pipe for connecting one pressure-adjusting unit 5 with the plurality of exhaust holes 23 and 23′.

The exhaust holes 23 and 23′ may be positioned at a height corresponding to a space between the first surface plate 3 and the second surface plate 44, and formed at the sidewall 2a of the chamber unit 2. The exhaust holes 23 and 23′ formed at the sidewall 2a of the chamber unit 2 are positioned at both sides of a gap between the substrate 100 supported by the first surface plate 3 and the carrier substrate 200 attached to the second surface plate 44.

The pressure-adjusting unit 5 discharges the gas through both sides of the gap between the substrate 100 and the carrier substrate 200, thereby discharging the gas of uniform flux through both sides of the gap between the substrate 100 and the carrier substrate 200. Thus, the substrate-bonding apparatus 1 prevents the pressure between the substrate 100 and the carrier substrate 200 from being non-uniform. Accordingly, the substrate-bonding apparatus 1 precisely controls the making the first area 210 first separated from the second surface plate 44 and brought into contact with the substrate 100, and making the second area 220 secondly separated from the second surface plate 44 and brought into contact with the substrate 100.

In the above description of the present invention, the chamber unit 2 includes the two exhaust holes 23 and 23′ formed at the both sides of the space between the first surface plate 3 and the second surface plate 44. However, the chamber unit 2 may include three or more exhaust holes 23 positioned at the height corresponding to the space between the first surface plate 3 and the second surface plate 44.

### Third Embodiment

Referring to FIGS. 10 and 16 to 19, the supporting unit 4 according to the third embodiment of the present invention includes a second surface plate 44 for supporting the carrier substrate 200. The second surface plate 44 is provided in the chamber unit 2, and is positioned next to the first surface plate 3. Accordingly, as the carrier substrate 200 is supported by the second surface plate 44, the carrier substrate 200 may be positioned next to the substrate 100 supported by the first surface plate 3. The carrier substrate 200 may also be attached to the second surface plate 44 by a suction force.

That is, the second surface plate 44 may include a vacuum hole for transferring the suction force supplied from a suction unit to the substrate 100. The suction unit suctions fluids through the vacuum hole of the second surface plate 44, thereby attaching the carrier substrate 200 to the second surface plate 44. In addition, the second surface plate 44 may be an electrostatic chuck. In this instance, the second surface plate 44 may include at least one electrode. In addition, the second surface plate 44 may include at least one adhesive rubber. In this instance, the carrier substrate 200 may be attached to the second surface plate 44 by adhesion of the adhesive rubber.

When the substrate-bonding apparatus 1 includes the supporting unit 4 according to the third embodiment of the present invention, a rotating unit 6 for rotating the first surface plate 3 and the second surface plate 44 is also provided. In more detail, the rotating unit 6 rotates the first surface plate 3 and the second surface plate 44 in opposite directions. The rotating unit 6 may rotate the first surface plate 3 and the second surface plate 44 so as to vertically stand both the substrate 100 supported by the first surface plate 3 and the carrier substrate 200 supported by the second surface plate 44.

Accordingly, the rotating unit 6 brings the substrate 100 supported by the first surface plate 3 into contact with the carrier substrate 200 supported by the second surface plate 44. In this instance, the first surface plate 3 may be rotatably combined with the chamber unit 2 (see FIG. 10). Further, the first surface plate 3 may be rotated with respect to a first rotating axis 3a by the rotating unit 6, and the second surface plate 44 may be rotatably combined with the chamber unit 2.

In addition, the second surface plate 44 may be rotated with respect to a second rotating axis 44a by the rotating unit 6. The first rotating axis 3a and the second rotating axis 44a may also be positioned between the first surface plate 3 and the second surface plate 44. Accordingly, when the rotating unit 6 rotates the first surface plate 3 and the second surface plate 44 in opposite directions, the substrate 100 supported by the first surface plate 3 and the carrier substrate 200 supported by the second surface plate 44 are rotated in opposite directions, and then brought into contact with each other.

The rotating unit 6 may also include a power source for providing a rotatory power, and a connecting mechanism for connecting the first rotating axis 3a and the second rotating axis 44a with each other. The power source may be a motor and the connecting mechanism may be a pulley or belt. In addition, the rotating unit 6 may include a first rotating unit connected with the first rotating axis 3a, and a second rotating unit connected with the second rotating axis 44a.

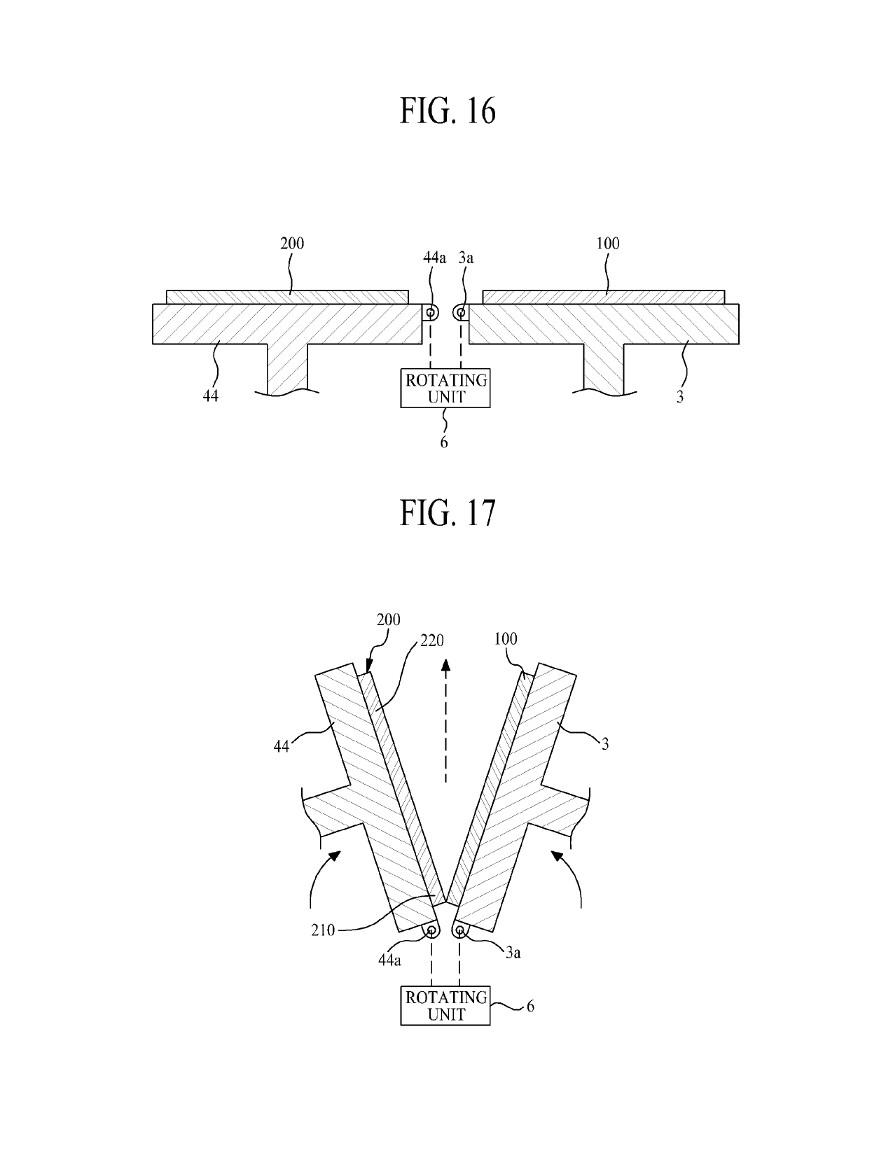

When the substrate-bonding apparatus 1 includes the supporting unit 4 according to the third embodiment of the present invention, the substrate 100 and the carrier substrate 200 are bonded to each other through the following operation. First, as shown in FIG. 16, the substrate 100 is supported by the first surface plate 3, and the carrier substrate 200 is supported by the second surface plate 44. The carrier substrate 200 supported by the second surface plate 44 is also positioned next to the substrate 100 supported by the first surface plate 3.

Then, as shown in FIG. 17, the rotating unit 6 rotates the first surface plate 3 and the second surface plate 44 in opposite directions. Thus, the rotating unit 6 rotates the first surface plate 3 and the second surface plate 44 in the direction for vertically standing both the substrate 100 supported by the first surface plate 3 and the carrier substrate 200 supported by the second surface plate 44, whereby the first area 210 of the carrier substrate 200 is first brought into contact with the substrate 100. In this instance, the first area 210 of the carrier substrate 200 corresponds to the edge portion of the carrier substrate 200.

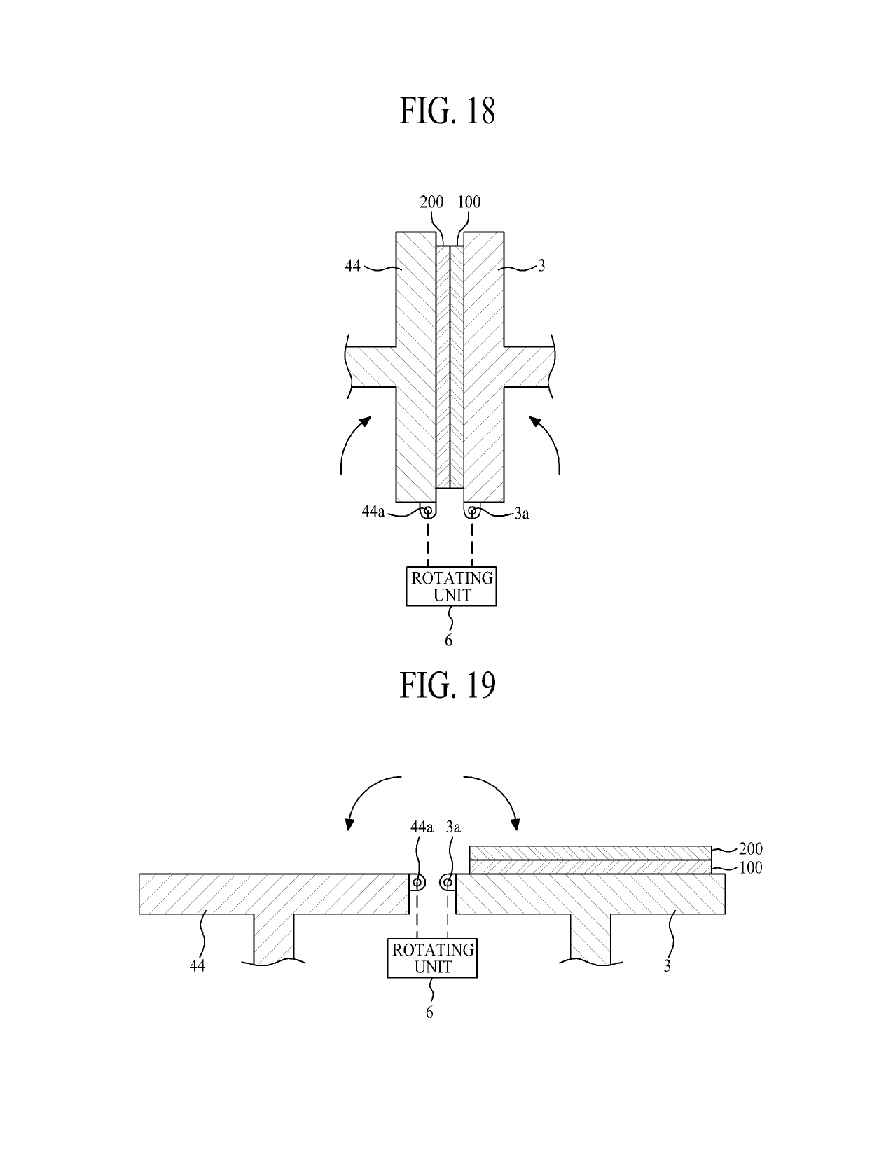

After the first area 210 of the carrier substrate 200 is brought into contact with the substrate 100, as shown in FIG. 18, the rotating unit 6 continuously rotates the first surface plate 3 and the second surface plate 44. Thus, the second area 220 of the carrier substrate 200 is gradually brought into contact with the substrate 100 while discharging the gas remaining between the substrate 100 and the carrier substrate 200. Accordingly, the substrate-bonding apparatus 1 prevents bubbles from occurring between the substrate 100 and the carrier substrate 200 when bonding the carrier substrate 200 to the substrate 100, thereby improving the quality of slim display device. The substrate 100 and the carrier substrate 200 stand vertically or stand in the nearly-vertical state, whereby the entire surfaces of the substrate 100 and the carrier substrate 200 are brought into contact with each other.

When the entire surfaces of the substrate 100 and the carrier substrate 200 are brought into contact with each other, the pressure-adjusting unit 5 (see FIG. 10) lowers the pressure inside the chamber unit 2 so as to make the vacuum state inside the chamber unit 2. Thus, the pressure-adjusting unit 5 may discharge the gas remaining between the substrate 100 and the carrier substrate 200 from the gap therebetween, thereby bonding the substrate 100 and the carrier substrate 200 to each other.

After bonding the substrate 100 and the carrier substrate 200 to each other, a bonded substrate obtained by bonding the carrier substrate 200 to the substrate 100 (hereinafter, referred to as ‘bonded substrate’) is attached to any one of the first surface plate 3 and the second surface plate 44. This process may be performed by maintaining adhesion in any one of the first surface plate 3 and the second surface plate 44, and removing adhesion from the other. The process for removing adhesion from any one of the first surface plate 3 and the second surface plate 44 may be performed by stopping the suction force of the suction unit, stopping the supply of power applied to the electrostatic chuck, or removing the adhesive rubber.

The process for attaching the bonded substrate to any one of the first surface plate 3 and the second surface plate 44 may be performed by removing adhesion from both the first surface plate 3 and the second surface plate 44 when bonding the substrate 100 and the carrier substrate 200 to each other, and providing adhesion to any one of the first surface plate 3 and the second surface plate 44 after completing the process for bonding the substrate 100 and the carrier substrate 200 to each other.

As shown in FIG. 19, the rotating unit 6 rotates the first surface plate 3 and the second surface plate 44 in opposite directions. Accordingly, when the bonded substrate is attached to the first surface plate 3 or the second surface plate 44, which is supplied with adhesion, the bonded substrate is rotated to be in the vertical state.

### Fourth Embodiment

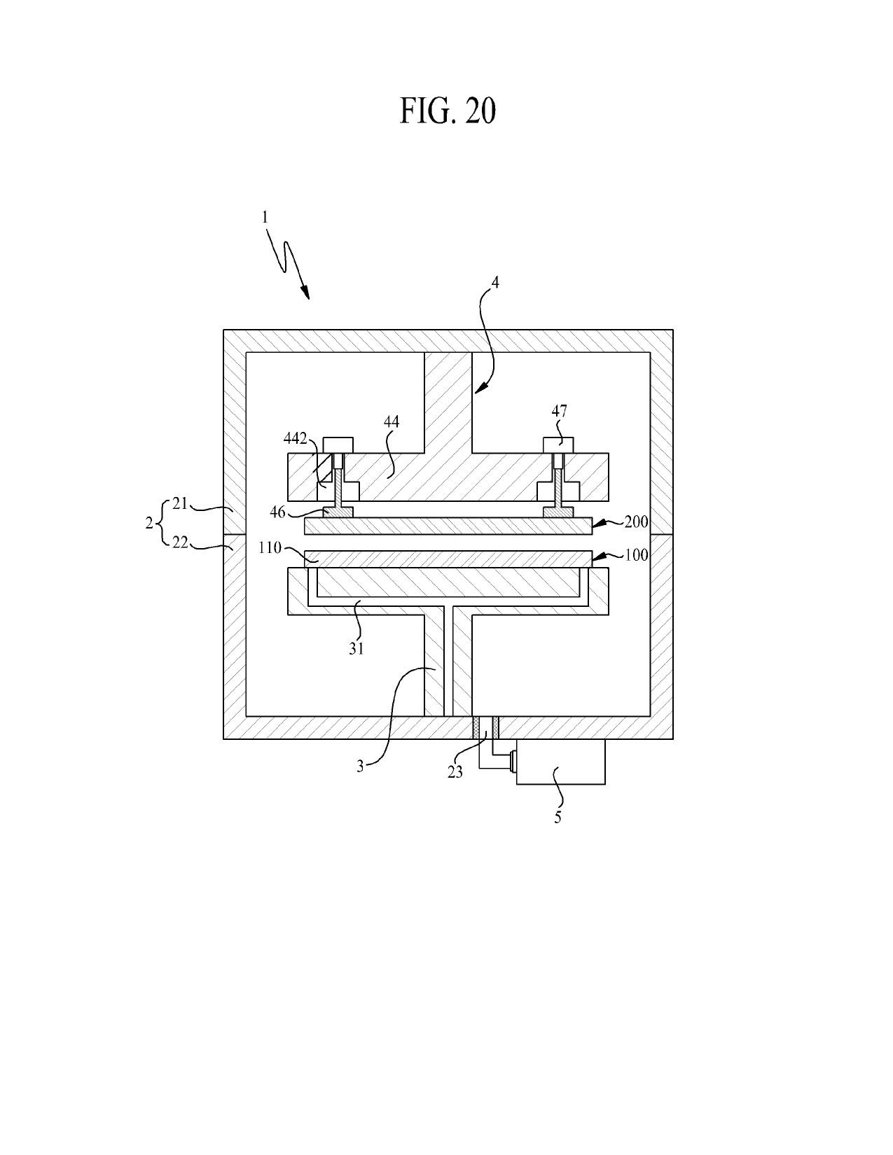

Referring to FIGS. 20 to 22, the supporting unit 4 according to the fourth embodiment of the present invention includes a second surface plate 44 provided at a predetermined interval from the first surface plate 3, an attaching unit 46 to which the carrier substrate 200 is attached, and a first elevating device 47 for elevating the attaching unit 46.

The second surface plate 44 is provided inside the chamber unit 2, and is positioned at a predetermined interval from the first surface plate 3 inside the chamber unit 2. The second surface plate 44 provided inside the chamber unit 2 is also positioned above the first surface plate 3. Further, the attaching unit 46 is movably provided in the second surface plate 44.

When the carrier substrate 200 is positioned above the substrate 100 supported by the first surface plate 3, the carrier substrate 200 is attached to the attaching unit 46. The attaching unit 46 may be elevated or lowered by the first elevating device 47. As shown in FIG. 20, the attaching unit 46 is elevated by the first elevating device 47 so that the carrier substrate 200 is positioned at a predetermined interval from the substrate 100 supported by the first surface plate 3.

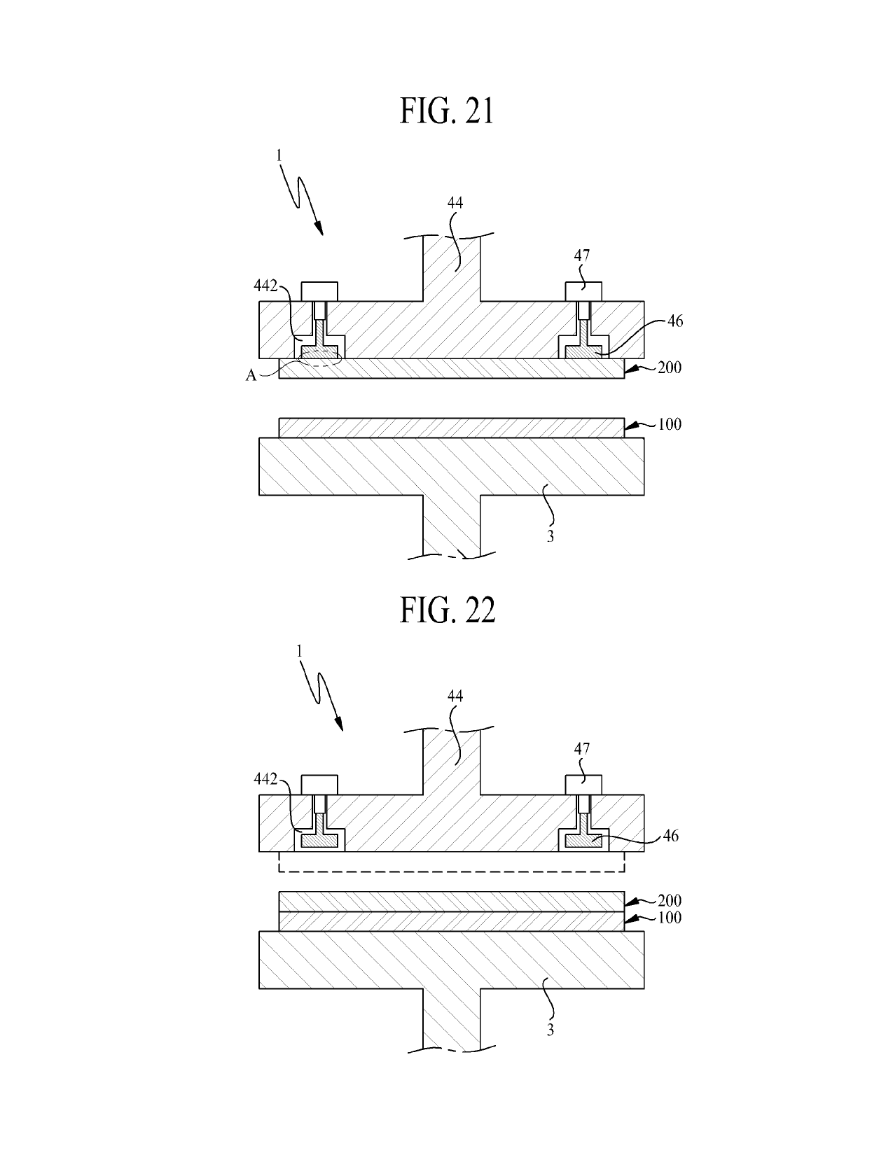

In this instance, the carrier substrate 200 is positioned while being apart from the substrate 100. Under this condition, as shown in FIG. 21, the attaching unit 46 is elevated to a contact position using the first elevating device 47. In particular, the contact position corresponds to a position where the carrier substrate 200 attached to the attaching unit 46 is brought into contact with the second surface plate 44.

After that, as shown in FIG. 22, the attaching unit 46 is elevated to a retreat position from the contact position by the first elevating device 47. The retreat position corresponds to a position where the attaching unit 46 is separated from the carrier substrate 200 brought into contact with the second surface plate 44. In this instance, the attaching unit 46 is elevated to be inserted into the inside of the second surface plate 44 by the first elevating device 47, whereby the attaching unit 46 retreats to be apart from the carrier substrate 200.

That is, even though the carrier substrate 200 attached to the attaching unit 46 is elevated from the contact position to the retreat position, the carrier substrate 200 being supported by the second surface plate 44 is separated from the attaching unit 46. Thus, the carrier substrate 200 naturally falls toward the substrate 100 supported by the first surface plate 3, whereby the carrier substrate 200 is brought into contact with the substrate 100 supported by the first surface plate 3.

Accordingly, in comparison with the damaged substrate 100 by the force applied using the pushing pin 300, the diaphragm 400, and the spraying device 500 shown in FIGS. 2 to 4, the substrate-bonding apparatus 1 brings the carrier substrate 200 into contact with the substrate 100 supported by the first surface plate 3 using the attaching unit 46 without applying the force to the substrate 100 supported by the first surface plate 3. Thus, the substrate-bonding apparatus 1 prevents the substrate 100 from being spotted or deformed when bringing the carrier substrate 200 into contact with the substrate 100 supported by the first surface plate 3, thereby improving the quality of slim display device using the substrate-bonding apparatus 1 according to an embodiment of the present invention.

When the attaching unit 46 is positioned at the contact position and the retreat position, the attaching unit 46 is positioned inside the second surface plate 44. That is, the second surface plate 44 includes a retreat groove 442 for inserting the attaching unit 46 thereinto. In addition, the retreat groove 422 is roughly identical in size to the portion of the attaching unit 46 to which the carrier substrate 200 is attached. The retreat groove 422 is also roughly identical in shape to the portion of the attaching unit 46. However, the retreat groove 442 may be formed in any shape allowing the attaching unit 46 retreat back into the second surface plate 44, for example, a cylinder shape or a rectangular parallelepiped.

Further, the supporting unit 4 according to the fourth embodiment of the present invention may include a plurality of attaching units 46. In particular, the attaching units 46 are movably combined with the second surface plate 44. The attaching units 46 provided at fixed intervals may also be combined with the second surface plate 44. In FIG. 20, two attaching units 46 are combined with the second surface plate 44. However, the supporting unit 4 according to the fourth embodiment of the present invention may include three or more attaching units 46. The second surface plate 44 also includes a corresponding number of retreat grooves 442 for the attaching units 46.

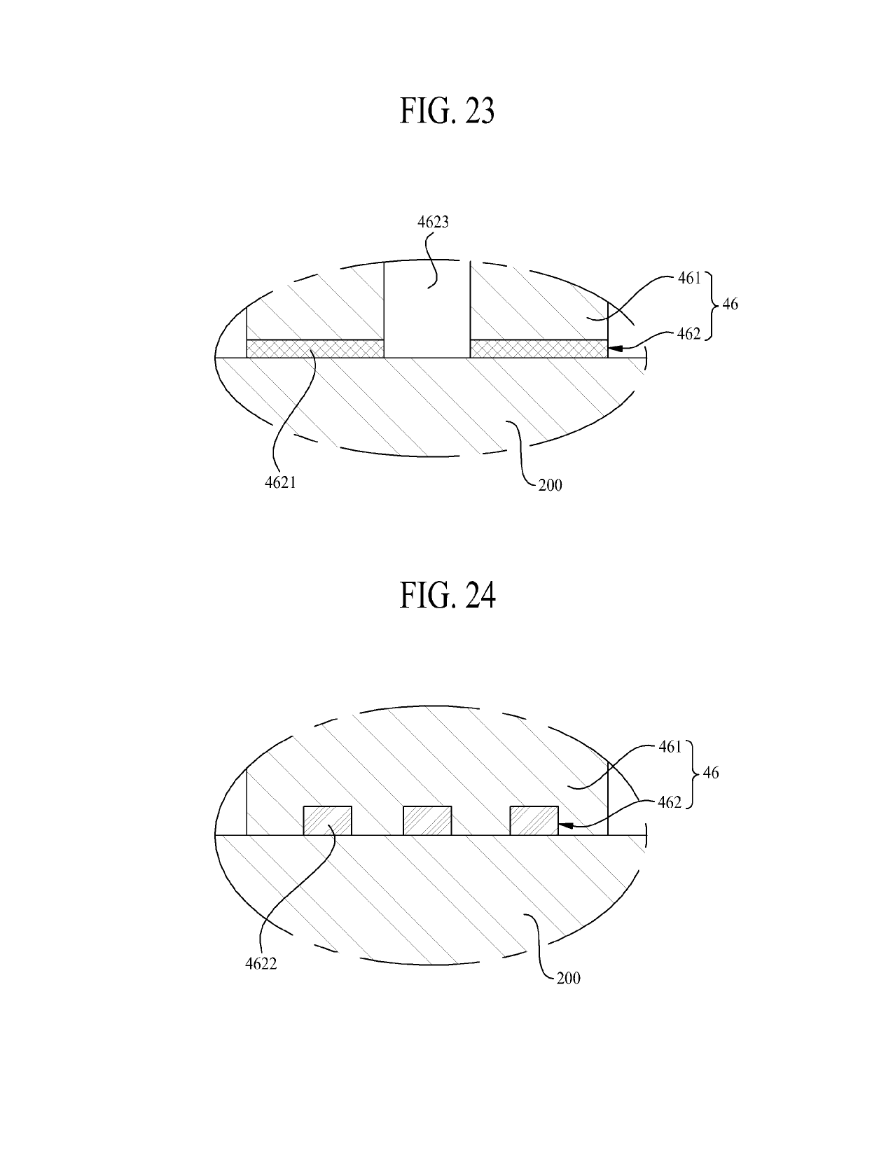

Referring to FIGS. 23 to 25, the attaching unit 46 includes an attaching pin 461 (see FIG. 23) combined with the first elevating device 47, and an attaching member 462 (see FIG. 23) combined with the attaching pin 461. The attaching pin 461 is elevated by the first elevating device 47 and is movably provided in the second surface plate 44. The attaching pin 461 may also be lowered to be protruding toward the substrate 100 from the second surface plate 44 and be retreated or retracted to the contact position using the first elevating device 47.

Further, the attaching member 462 is combined with the attaching pin 461 and attaches the carrier substrate 200 to the attaching pin 461. Accordingly, as the carrier substrate 20 is attached to the attaching member 462, the carrier substrate 200 can be attached to the attaching pin 461.

In addition, the attaching member 462 includes adhesive rubber 4621 (see FIG. 23) such that the carrier substrate 200 is attached to the attaching member 462 by adhesion of the adhesive rubber 4621. When the attaching pin 461 is elevated from the contact position to the retreat position, the adhesive rubber 4621 is separated from the carrier substrate 200. Accordingly, as the carrier substrate 200 is separated from the adhesive rubber 4621, the carrier substrate 200 is brought into contact with the substrate 100 supported by the first surface plate 3.

As shown in FIG. 23, the adhesive rubber 4621 may cover the entire area on the surface of the attaching pin 461, where the surface of the attaching pin 461 corresponds to the surface facing toward the carrier substrate 200. The adhesive rubber 4621 may also have any shape capable of being attached to the carrier substrate 200, for example, a rectangular plate shape, discus type, etc. In addition, the attaching member 462 may include a plurality of adhesive rubbers 4621. In this instance, the plural adhesive rubbers 4621 provided at fixed intervals may be connected with the attaching pin 461. Also, the plural adhesive rubbers 4621 may be connected with the attaching pin 461 so as to be inserted into the attaching pin 461. A vacuum channel can also be provided in the attaching unit 46 to secure the carrier substrate 200.

In addition, the attaching member 462 includes an electrode 4622 in FIG. 24. Thus, the carrier substrate 200 can be attached to the attaching pin 461 because of an electrostatic force produced by the electrode 4622. That is, the attaching unit 46 functions as an electrostatic chuck (ESC) using the electrode 4622. When the attaching pin 461 is elevated from the contact position to the retreat position, the electrode 4622 is separated from the carrier substrate 200. Accordingly, as the carrier substrate 200 is separated from the electrode 4622, the carrier substrate 200 is brought into contact with the substrate 100 supported by the first surface plate 3.

When the attaching pin 461 is elevated from the contact position to the retreat position, the electrode 4622 can be operated to dissipate the electrostatic force. This operation may be accomplished by stopping the power supply to the electrode 4622. Accordingly, when the attaching pin 461 is elevated from the contact position to the retreat position, the electrode 4622 easily separates the carrier substrate 200 from the attaching pin 461.

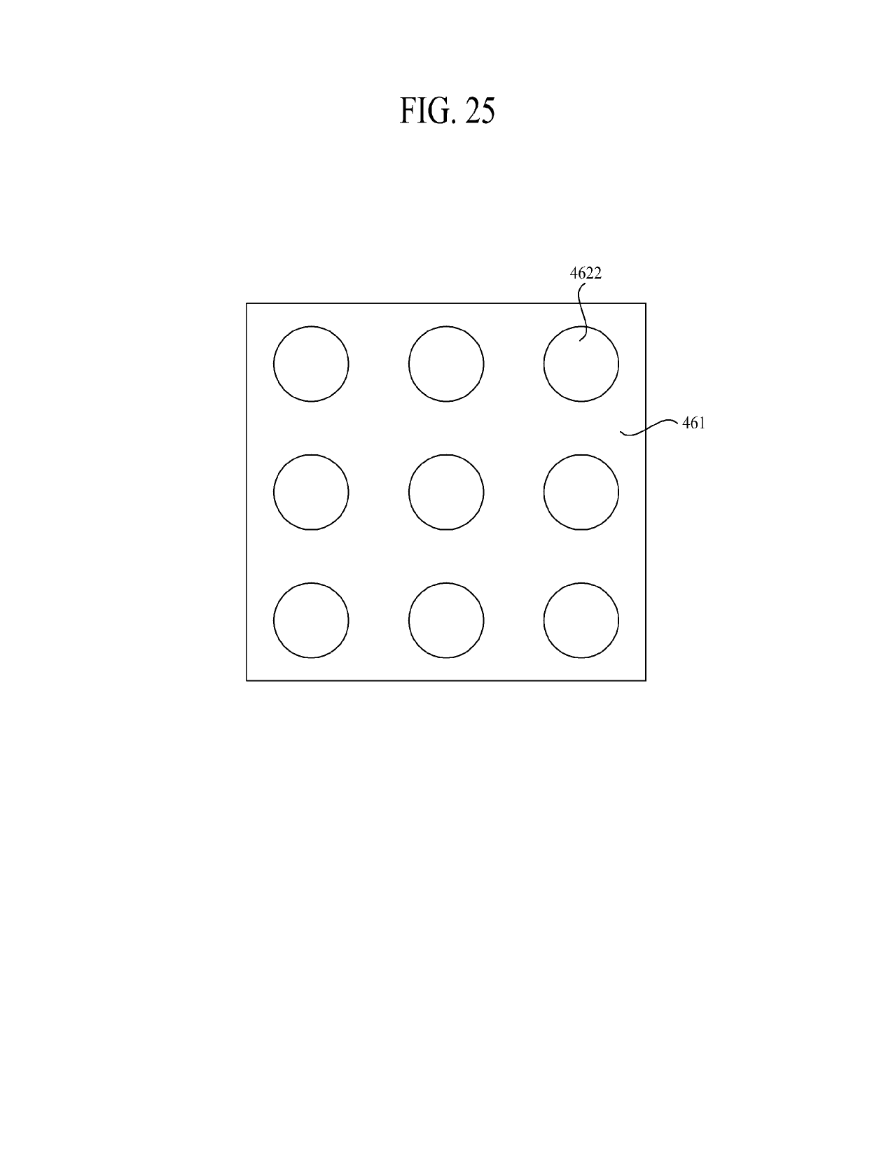

In addition, the attaching member 462 may include a plurality of electrodes 4622. When the electrodes 462 are provided at fixed intervals, the electrodes 462 may be combined with the attaching pin 461. As shown in FIG. 25, when the electrodes 4622 are arranged in a matrix configuration, the electrodes 4622 may be combined with the attaching pin 461. In FIG. 25, the electrodes 4622 are arranged in (3×3) matrix configuration, and nine electrodes 4622 are combined with the attaching pin 461. However, the electrodes 4622 less or greater than 9 may be combined with the attaching pin 461.

As shown in FIG. 24, the electrodes 4622 may be combined with the attaching pin 461 so as to be inserted into the attaching pin 461. In this instance, when the electrodes 4622 are inserted into the attaching pin 461, the electrodes 4622 are not protruding out of the attaching pin 461. However, when the electrodes 4622 are inserted into the attaching pin 461, the electrodes 4622 may be protruding out of the attaching pin 461. In addition, the attaching member 462 may include one electrode 4622. In this instance, the one electrode 4622 may be combined with the attaching pin 461 so as to cover the entire area on the surface of the attaching pin 461, where the surface of the attaching pin 461 corresponds to the surface facing toward the carrier substrate 200.

Further, the electrodes 4622 may be formed in the same shape and same size. Also, the electrodes 4622 are provided at fixed intervals. In the substrate-bonding apparatus 1 according to an embodiment of the present invention, the electrostatic force produced by the electrodes 4622 distributes stress applied to the carrier substrate 200, thereby preventing the carrier substrate 200 from being deformed or damaged. The attaching pin 461 may also be formed of aluminum.

In addition, the attaching unit 46 may include a suction hole 4623 (FIG. 23) formed in the attaching pin 461. That is, the suction hole transfers a suction force provided from a suction unit to the carrier substrate 200. Accordingly, the carrier substrate 200 can be attached to the attaching pin 461 by the suction force provided from the suction unit. When the attaching pin 461 is elevated from the contact position to the retreat position, the suction unit may dissipate the suction force. Thus, when the attaching pin 461 is elevated from the contact position to the retreat position, the carrier substrate 200 is easily separated from the attaching pin 461. The attaching member 462 may also include a plurality of suction holes. The suction holes formed in the attaching pin 461 may also be provided at fixed intervals.

In addition, the attaching unit 46 attaches the carrier substrate 200 to the attaching pin 461 using any one or more of the adhesive rubber 4621, the electrode 4622, and the suction hole. That is, the carrier substrate 200 may be combined with the attaching pin 461 using adhesion, electrostatic force, and/or suction force.

Referring to FIGS. 20 to 22, the first elevating device 47 elevates the attaching unit 46. When the carrier substrate 200 is loaded into the inside of the chamber unit 2, as shown in FIG. 20, the first elevating device 47 lowers the attaching unit 46 so as to position the carrier substrate 200 spaced from the substrate 100 and the second surface plate 44. Under this condition, the first elevating device 47 elevates the attaching unit 46 to the contact position, as shown in FIG. 21. Accordingly, the carrier substrate 200 attached to the attaching unit 46 is brought into contact with the second surface plate 44. After that, as shown in FIG. 22, the first elevating device 47 elevates the attaching unit 46 to the retreat position. Accordingly, as the attaching unit 46 is elevated to the retreat position in the direction being separated from the carrier substrate 200, the carrier substrate 200 being supported by the second surface plate 44 is separated from the attaching unit 46, and is then brought into contact with the substrate 100 supported by the first surface plate 3.

In addition, then the attaching unit 46 is positioned at the contact position, the first elevating device 47 stops the attaching unit 46, and then elevates the attaching unit 46 from the contact position to the retreat position. Thus, it is possible to decrease an impact applied to the carrier substrate 200 when the carrier substrate 200 is separated from the attaching unit 46 according to the elevation of attaching unit 46 to the retreat position.

Also, before the attaching unit 46 is positioned at the contact position, the first elevating device 47 gradually lowers the speed of elevating the attaching unit 46 so that it is possible to decrease the impact applied to the carrier substrate 200. The first elevating device 47 may continuously elevate the attaching unit 46 the retreat position without stopping at the contact position. In this instance, the first elevating device 47 decreases a time period consumed for separating the carrier substrate 200 from the attaching unit 46, thereby decreasing a time period consumed for bonding the carrier substrate 200 to the substrate 100.

In addition, the first elevating device 47 may be combined with the second surface plate 44. The first elevating device 47 may also elevate the attaching unit 46 by a cylinder method using a hydraulic cylinder or a pneumatic cylinder; a ball screw method using a motor and a ball screw; a gear method using a motor, a rack gear, and a pinion gear; a belt method using a motor, a pulley, and a belt; or a linear motor. Further, the first elevating device 47 may be combined with the chamber unit 2.

If the plural attaching units 46 are combined with the second surface plate 44, the supporting unit 4 according to the fourth embodiment of the present invention may include the plurality of first elevating devices 47. The supporting unit 4 according to the fourth embodiment of the present invention may also include the first elevating devices 47 whose number approximately corresponds to the number of attaching units 46.

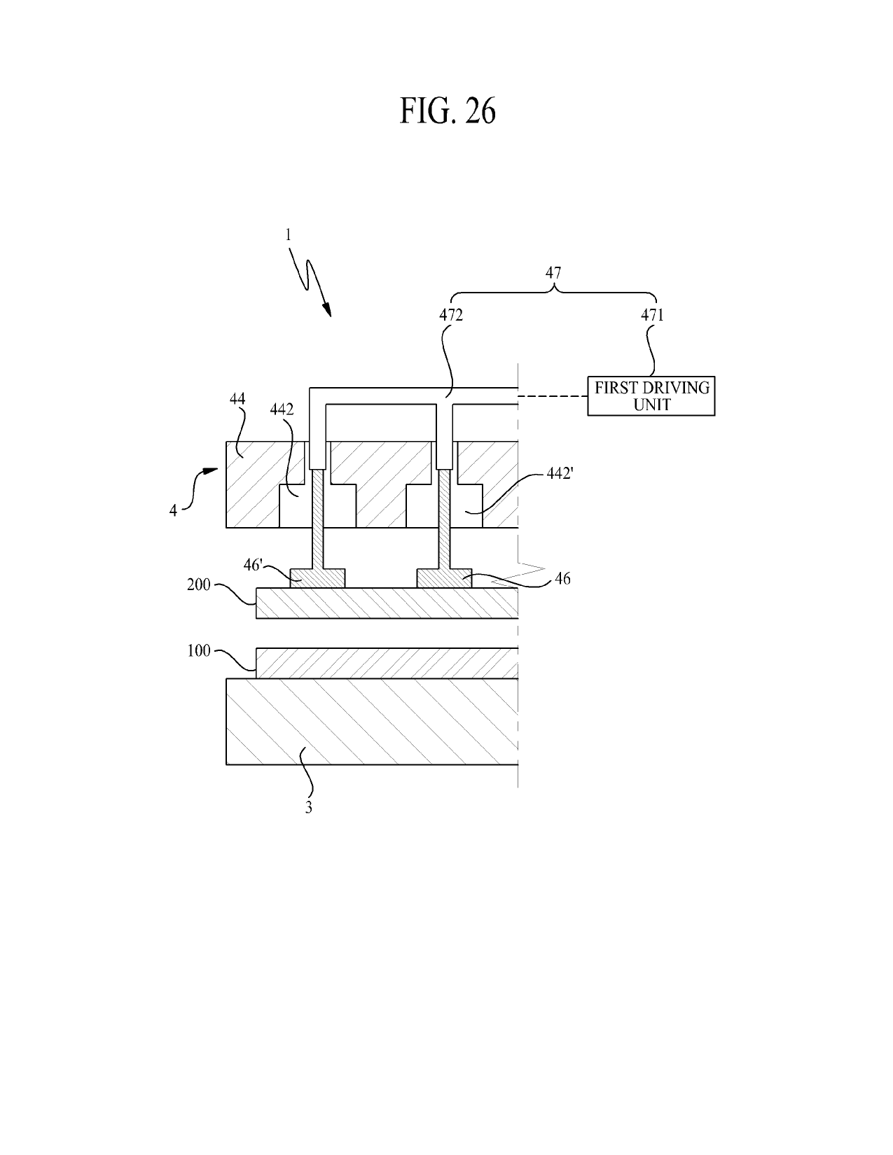

Referring to FIG. 26, the first elevating device 47 may include a first driving unit 471 for producing a driving force to elevate the attaching units 46 and 46′, and a first connecting unit for connecting the attaching units 46 and 46′ with the first driving means 471. The first driving unit 471 may be combined with the first surface plate 44 or the chamber unit 2. The first driving unit 471 can elevate the first connecting unit 472 by a cylinder method using a hydraulic cylinder or a pneumatic cylinder; a ball screw method using a motor and a ball screw; a gear method using a motor, a rack gear, and a pinion gear; a belt method using a motor, a pulley, and a belt; or a linear motor.

One end of the first connecting unit 472 is connected with the first driving unit 471, and the other end of the first connecting unit 472 is combined with the attaching units 46 and 46′. Accordingly, the first elevating device 47 can elevate the plurality of attaching units 46 and 46′ at the same time using one of the first driving unit 471. Compared to using a plurality of first driving units 471 to elevate the plurality of attaching units 46 and 46′, the substrate-bonding apparatus 1 includes a decreased number of first driving units 471, thereby decreasing the manufacturing cost.

In addition, the first connecting unit 472 and the attaching units 46 and 46′ may be positioned in opposite directions with respect to the second surface plate 44. In this instance, the second surface plate 44 may include a plurality of first through holes to combine the first connecting unit 472 and the attaching units 46 and 46′ with each other. The first through holes may be respectively connected with the retreat grooves 442.

Referring to FIGS. 20 to 26, if the substrate-bonding apparatus 1 includes the supporting unit 4 according to the fourth embodiment of the present invention, the attaching unit 46 is elevated to the contact position, and then the pressure-adjusting unit 5 (see FIG. 20) lowers the pressure inside the chamber unit 2 to the first pressure. When elevating the attaching unit 46 from the contact position to the retreat position, the pressure-adjusting unit 5 can adjust the pressure inside the chamber unit 2 to the first pressure. After the attaching unit 46 is elevated to the retreat position, the pressure-adjusting unit 5 can maintain the pressure inside the chamber unit 2 to the first pressure.

When the carrier substrate 200 is brought into contact with the substrate 100 supported by the first surface plate 3, the pressure-adjusting unit 5 secondly adjusts the pressure inside the chamber unit 2 to the second pressure which is lower than the first pressure. Accordingly, as the pressure-adjusting unit 5 lowers the pressure inside the chamber unit 2, the pressure inside the chamber unit 2 is adjusted to the second pressure.

Thus, the pressure-adjusting unit 5 can completely discharge the gas remaining the substrate 100 and the carrier substrate 200 from the gap between the substrate 100 and the carrier substrate 200, thereby bonding the substrate 100 and the carrier substrate 200 to each other. In addition, the substrate-bonding apparatus 1 may include a plurality of pressure-adjusting units 5.

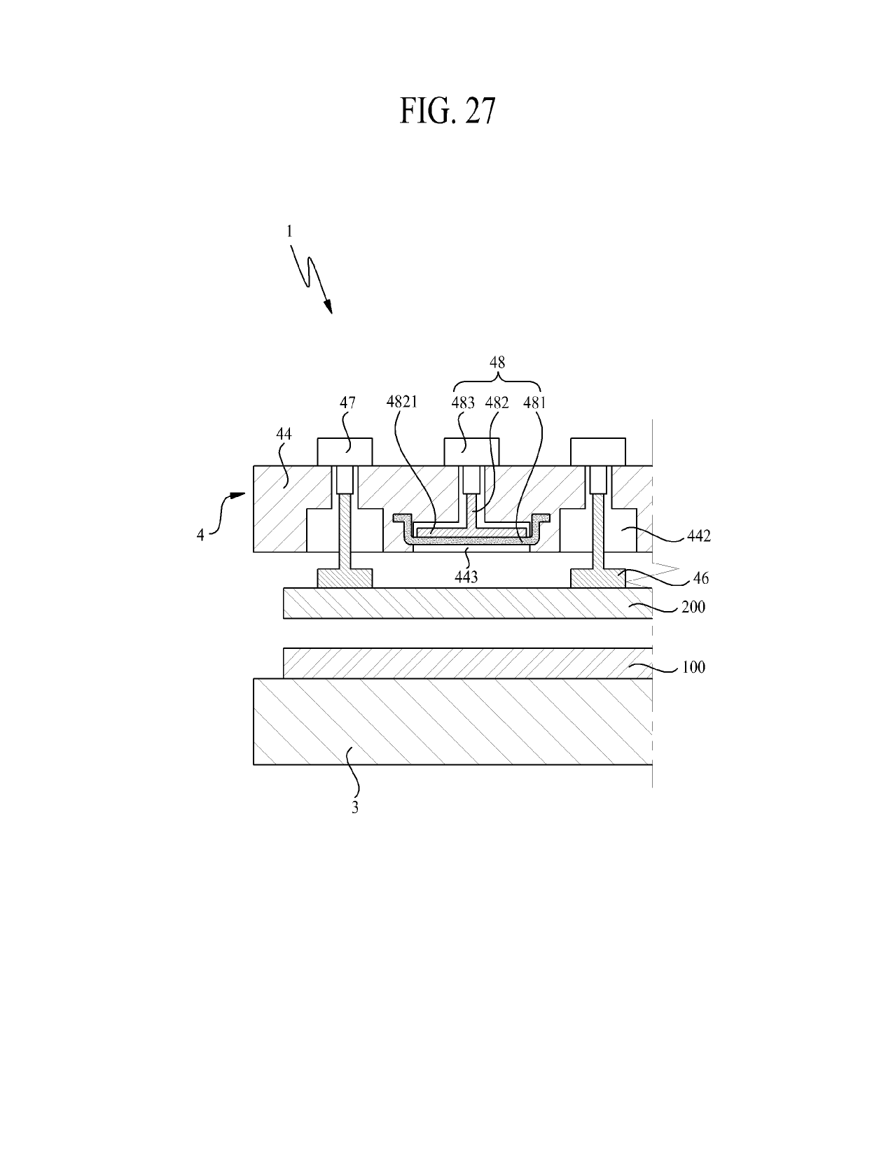

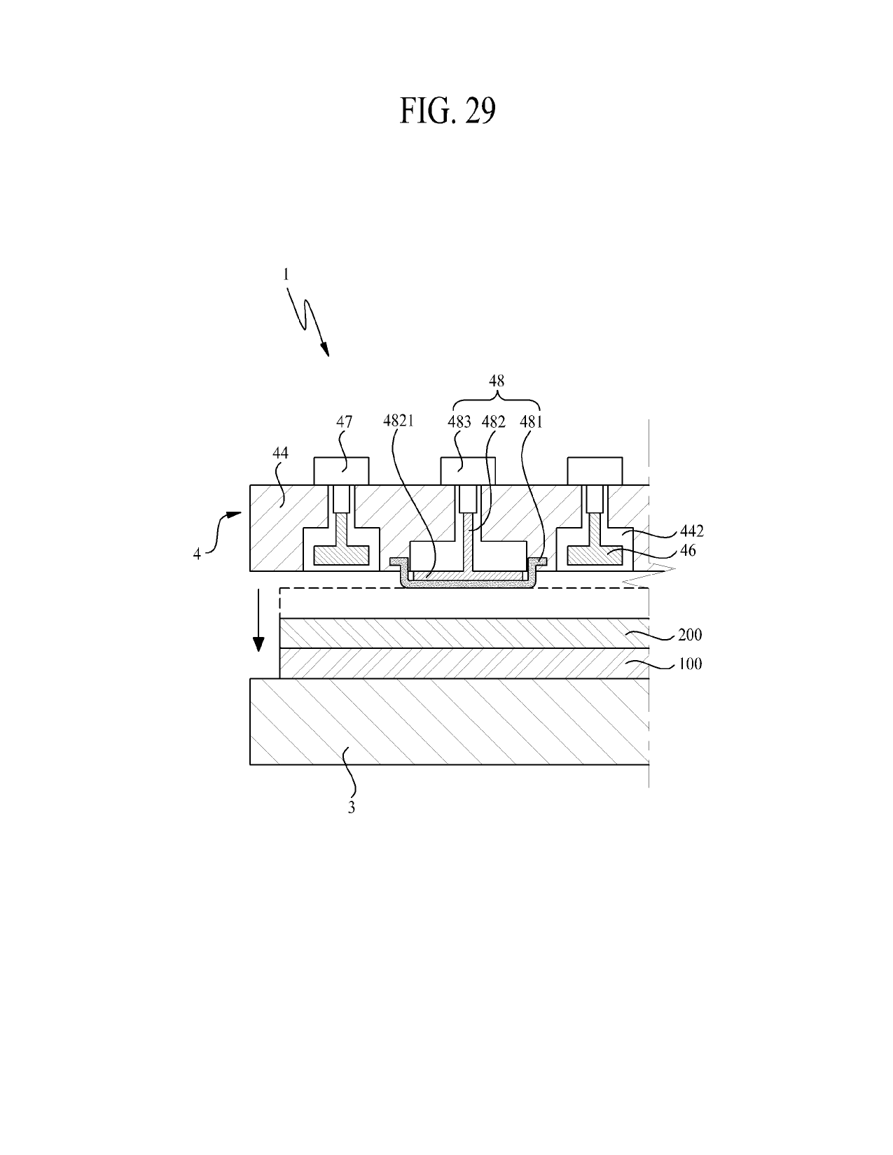

Referring to FIGS. 27 to 29, the supporting unit 4 according to the fourth embodiment of the present invention may further include a separating unit 48 for separating the carrier substrate 200 from the attaching unit 46. The separating unit 48 pushes the carrier substrate 200 attached to the attaching unit 46 so as to separate the carrier substrate 200 from the attaching unit 46. Accordingly, as the attaching unit 46 is elevated, the carrier substrate 200 is brought into contact with the separating unit 48.

Then, the attaching unit 46 is elevated to the retreat position, whereby the carrier substrate 200 is supported by the separating unit 48, and is then separated from the attaching unit 46. In this instance, the contact position may be the position where the carrier substrate 200 attached to the attaching unit 46 is brought into contact with the separating unit 48.

When the carrier substrate 200 attached to the attaching unit 46 is brought into contact with the second surface plate 44, the separating unit 48 may push the carrier substrate 200. When the carrier substrate 200 is pushed by the separating unit 48, the attaching unit 46 may be elevated to the retreat position. Accordingly, as the attaching unit 46 is elevated to the retreat position, the carrier substrate 200 may be separated from the attaching unit 46 by a supporting force of the second surface plate 44 and a pushing force provided from the separating unit 48.

Thus, the substrate-bonding apparatus 1 easily separates the carrier substrate 200 from the attaching unit 46, and brings the carrier substrate 200 into contact with the substrate 100 supported by the first surface plate 3. The separating unit 48 may also include a diaphragm 481 combined with the second surface plate 44, a pushing member 482 for pushing the diaphragm 481, and a second elevating device 483 for elevating the pushing member 482.

Further, both ends of the diaphragm 481 are fixedly combined with the second surface plate 44, and the central portion of the diaphragm 481 expands owing to a pushing force of the pushing member 482, thereby pushing the carrier substrate 200 attached to the attaching unit 46. When the pushing force of the pushing member 482 dissipates, the diaphragm 481 is restored to its original shape. According to whether or not the diaphragm 481 is pushed by the pushing member 482, the diaphragm 481 may be formed of an elastic material.

In addition, the pushing member 482 is movably provided in the second surface plate 44. Accordingly, as the pushing member 482 is lowered by the first elevating device 483, the pushing member 482 pushes the diaphragm 481, thereby expanding the diaphragm 481. Thus, the diaphragm 481 pushes the carrier substrate 200 attached to the attaching unit 46, whereby the carrier substrate 200 is separated from the attaching unit 46.

Therefore, as the pushing member 482 is elevated by the second elevating device 483, the pushing force for the diaphragm 481 is removed so that the diaphragm 481 is restored to its original shape. In this instance, the second surface plate 44 includes an inserting groove 443 (see FIG. 27) into which the pushing member 482 is inserted.

Further, the pushing member 482 can be elevated by the second elevating device 483 so that the pushing member 482 is inserted into the inserting groove 443. Also, the pushing member 482 can be lowered by the second elevating device 483 so that the pushing member 482 protrudes out of the second surface plate 44. In this instance, the inserting groove 443 may be formed in shape and size suitable for having the pushing member 482 and the diaphragm 481 being inserted thereinto.

In addition, the pushing member 482 includes a pushing plate 4821 for bringing the diaphragm 481 into surface-contact with the carrier substrate 200. The surface of the pushing plate 4821 being in contact with the diaphragm 481 may be flat. Accordingly, as the pushing plate 4821 moves the diaphragm 481 at an entirely-uniform distance, the diaphragm 481 is brought into surface-contact with the carrier substrate 200.

Thus, the substrate-bonding apparatus 1 precisely moves the diaphragm 481 to a predetermined position where the carrier substrate 200 is separated from the substrate 100 supported by the first surface plate 3 when separating the carrier substrate 200 from the attaching unit 46, so as to prevent the diaphragm 481 from pushing the substrate 100 being in contact with the carrier substrate 200. Accordingly, the substrate-bonding apparatus 1 prevents the partial spot or deformation of the substrate 100 using the diaphragm 481, thereby improving the quality of slim display device.

The pushing plate 4821 may also be formed in a rectangular plate shape, but may be formed in any shape with the surface being in flat contact with the diaphragm 481, for example, discus type. In addition, the separating unit 48 may include a plurality of pushing members 482. The pushing members 482 are movably combined with the second surface plate 44.

Further, the pushing members 482 provided at fixed intervals may be combined with the second surface plate 44. When the pushing members 482 are positioned between the attaching units 46, the pushing members 482 may be combined with the second surface plate 44. The separating unit 48 may include a corresponding number of diaphragms 481 for the pushing members 482.

In addition, the second surface plate 44 may include the inserting grooves 443 whose number approximately corresponds to the number of pushing members 482. Further, the second elevating device 483 may expand the diaphragm 481 by elevating the pushing member 482. When the carrier substrate 200 is loaded into the inside of the chamber unit 2, as shown in FIG. 27, the second elevating device 483 elevates the pushing member 482.

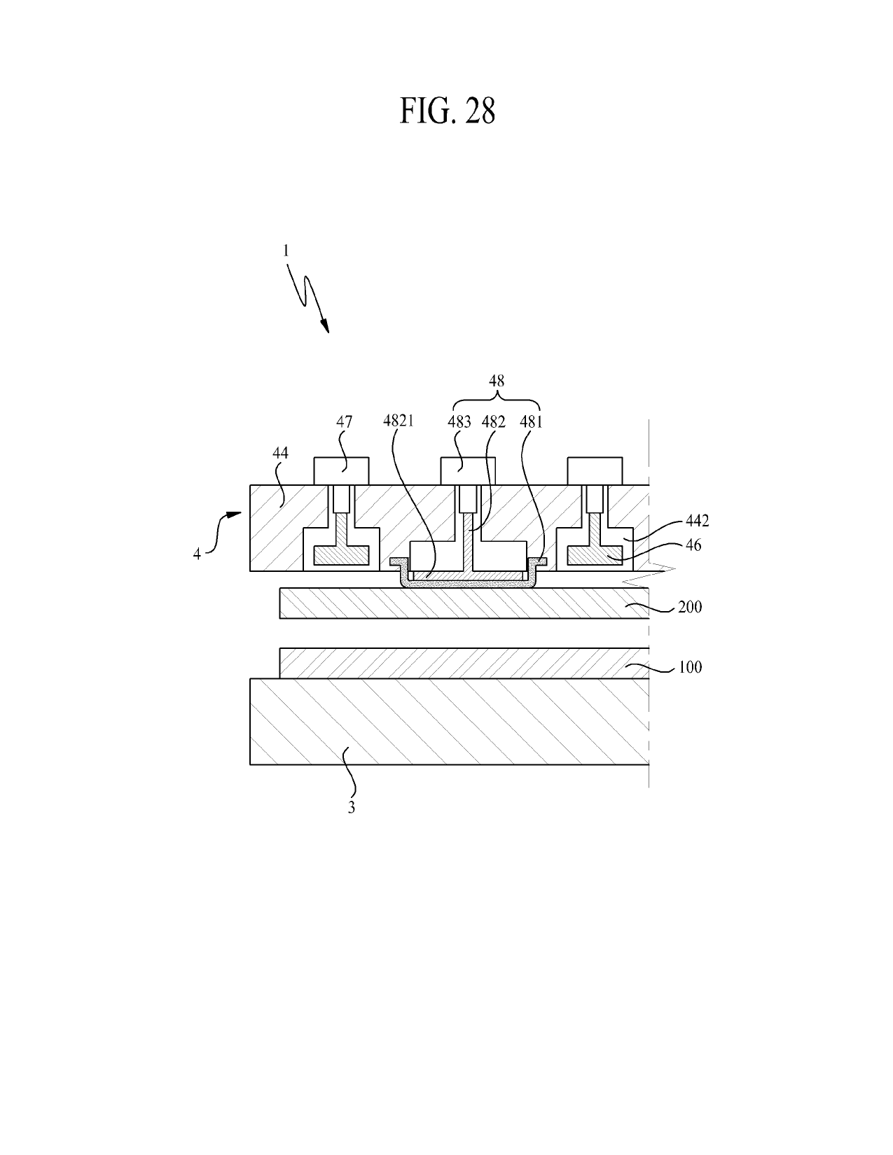

In this instance, the second elevating device 483 can elevate the pushing member 482 so as to insert the pushing member 482 and the diaphragm 481 into the inside of the second surface plate 44. Under this condition, as shown in FIG. 28, when the first elevating device 47 elevates the attaching unit 46 to the retreat position, the second elevating device 483 lowers the pushing member 482. Accordingly, the diaphragm 481 is pushed by the pushing member 482, and is then expanded, whereby the diaphragm 481 moves toward the carrier substrate 200 attached to the attaching unit 46.

As the diaphragm 481 is pushed, the carrier substrate 200 is separated from the attaching unit 46. In this instance, the second elevating device 483 can lower the pushing member 482 up to the position where the carrier substrate 200 is separated from the attaching unit 46, and is simultaneously separated from the substrate 100 supported by the first surface plate 3. Accordingly, as the carrier substrate 200 is separated from the attaching unit 46, as shown in FIG. 28, the carrier substrate 200 falls freely or descends toward the substrate 100 supported by the first surface plate 3, whereby the carrier substrate 200 is brought into contact with the substrate 100 supported by the first surface plate 3.

In addition, the second elevating device 483 may be combined with the second surface plate 44 and can elevate the pushing member 482 by a cylinder method using a hydraulic cylinder or a pneumatic cylinder; a ball screw method using a motor and a ball screw; a gear method using a motor, a rack gear, and a pinion gear; a belt method using a motor, a pulley, and a belt; or a linear motor. In addition, the second elevating device 483 may be combined with the chamber unit 2. If plural pushing members 482 are combined with the second surface plate 44, the separating unit 48 may include a plurality of second elevating devices 483. The separating unit 48 also includes a corresponding number of the second elevating devices 483 for the pushing members 482.

In addition, the second elevating device 483 may include a second driving unit for producing a driving force to elevate the pushing members 482, and a second connecting unit for connecting the pushing members 482 with the second driving unit. The second driving unit may be combined with the second surface plate 44 or the chamber unit 2. The second driving unit can also elevate the second connecting unit by a cylinder method using a hydraulic cylinder or a pneumatic cylinder; a ball screw method using a motor and a ball screw; a gear method using a motor, a rack gear, and a pinion gear; a belt method using a motor, a pulley, and a belt; or a linear motor.

One end of the second connecting unit is connected with the second driving unit, and the other end of the second connecting unit is combined with the pushing members 482. Accordingly, the second elevating device 483 can elevate the plurality of pushing members 482 at the same time using one of the second driving units. Compared with a plurality of second driving units to elevate the plurality of pushing members 482, the substrate-bonding apparatus 1 includes a decreased number of second driving units, thereby decreasing a manufacturing cost.

Further, the second connecting unit and the pushing members 482 may be positioned in opposite directions with respect to the second surface plate 44. In this instance, the second surface plate 44 may include a plurality of second through holes to combine the second connecting unit and the pushing members 482 with each other. The second through holes may be respectively connected with the inserting grooves 443.

Hereinafter, a method for manufacturing the bonded substrate according to the embodiment of the present invention will be described with reference to the accompanying drawings.

Referring to FIGS. 1 to 29, the carrier substrate 200 is bonded to the substrate 100 for manufacturing the display device. The bonded substrate may be manufactured as the slim display device. In particular, before completing the process for manufacturing the display device, the bonded substrate may be manufactured as the slim display device by removing the carrier substrate 200 from the substrate 100.

First, the substrate 100 is positioned on the first surface plate 3. This process may be performed by loading the substrate 100 to the inside of the chamber unit 2 using a transferring device, and positioning the loaded substrate 100 on the first surface plate 3. When the substrate 100 is placed onto the first surface plate 3 using the transferring device, the substrate 100 can be attached to the first surface plate 3 using any one of adhesion, electrostatic force, and suction force.

Then, the carrier substrate 200 is positioned in the supporting unit 4. This process may be performed by loading the carrier substrate 200 into the inside of the chamber unit 2, and positioning the carrier substrate 200 in the supporting unit 4. The carrier substrate 200 is positioned at a predetermined interval from the substrate 100.

After that, the carrier substrate 200 is brought into contact with the substrate 100 supported by the first surface plate 3. This process may be performed by bringing the carrier substrate 200 into contact with the substrate 100 supported by the first surface plate 3.

Then, the carrier substrate 200 is bonded to the substrate 100 supported by the first surface plate 3. This process may be performed by lowering the pressure inside the chamber unit 2 using the pressure-adjusting unit 5 when the carrier substrate 200 is brought into contact with the substrate 100 supported by the first surface plate 3. The pressure-adjusting unit 5 can also lower the pressure inside the chamber unit 2 so as to make the vacuum state inside the chamber unit 2. Accordingly, the pressure-adjusting unit 5 discharges the gas remaining between the substrate 100 and the carrier substrate 200 from the gap therebetween, thereby bonding the substrate 100 and the carrier substrate 200 to each other.

Thus, the method for manufacturing the bonded substrate according to an embodiment of the present invention bonds the carrier substrate 200 to the substrate 100 supported by the first surface plate 3 without applying the force toward the substrate 100 supported by the first surface plate 3. The method for manufacturing the bonded substrate according to an embodiment of the present invention prevents the substrate 100 from being spotted or deformed when bonding the carrier substrate 200 to the substrate 100 supported by the first surface plate 3.

Also, the method for manufacturing the bonded substrate according to an embodiment of the present invention prevents bubbles from occurring between the substrate 100 and the carrier substrate 200 by discharging the gas remaining between the substrate 100 and the carrier substrate 200 from the gap therebetween when bonding the carrier substrate 200 to the substrate 100 supported by the first surface plate 3. As a result, the quality of the slim display device is improved.

In addition, the method for manufacturing the bonded substrate according to an embodiment of the present invention includes lowering the pressure inside the chamber unit 2 so as to make the first vacuum state inside the chamber unit 2 before the process for bring the carrier substrate 200 into contact with the substrate 100 supported by the first surface plate 3. This process may be performed by lowering the pressure inside the chamber unit 2 so as to make the first vacuum state inside the chamber unit 2 using pressure-adjusting unit 5.

When the inside of the chamber unit 2 becomes the first vacuum state, the process for bring the carrier substrate 200 into contact with the substrate 100 supported by the first surface plate may be performed. Accordingly, the method for manufacturing the bonded substrate according to an embodiment of the present invention decreases the gas remaining between the substrate 100 and the carrier substrate 200 when bringing the carrier substrate 200 into contact with the substrate 100. After the first area 210 of the carrier substrate 200 is first brought into contact with the substrate 100, the pressure-adjusting unit 5 first lowers the pressure inside the chamber unit 2 so as to make the first vacuum state inside the chamber unit 2.

When the method for manufacturing the bonded substrate according to an embodiment of the present invention includes the process for first lowering the pressure inside the chamber unit 2 so as to make the first vacuum state inside the chamber unit 2, the process for bonding the carrier substrate 200 to the substrate 100 supported by the first surface plate 3 includes secondly lowering the pressure inside the chamber unit 2 a little more so as to make the second vacuum state inside the chamber unit 2.

Thus, the method for manufacturing the bonded substrate according to an embodiment of the present invention may bond the carrier substrate 200 to the substrate 100 by completely discharging the gas remaining between the substrate 100 and the carrier substrate 200 from the gap between the substrate 100 and the carrier substrate 200.

Referring to FIGS. 1 to 29, the method for manufacturing the bonded substrate according to an embodiment of the present invention may include the various embodiments of the supporting unit 4. When using the supporting unit 4 according to the first to third embodiments of the present invention, the process for bringing the carrier substrate 200 into contact with the substrate 100 supported by the first surface plate 3 may be performed by first bring the first area 210 of the carrier substrate 200 into contact with the substrate 100 supported by the first surface plate 3, and secondly bring the second area 220 of the carrier substrate 200 into contact with the substrate 100 supported by the first surface plate 3.

After the supporting unit 4 brings the first area 210 of the carrier substrate 200 into contact with the substrate 100 supported by the first surface plate 3, the supporting unit 4 brings the second area 220 of the carrier substrate 200 into contact with the substrate 100 supported by the first surface plate 3. In the method for manufacturing the bonded substrate according to an embodiment of the present invention, some area of the carrier substrate 200 is first brought into contact with the substrate 100, and then the remaining area of the carrier substrate 200 is gradually brought into contact with the substrate 100 by discharging the gas remaining between the substrate 100 and the carrier substrate 200.

Thus, the method for manufacturing the bonded substrate according to an embodiment of the present invention prevents bubbles from occurring between the substrate 100 and the carrier substrate 200 when bonding the substrate 100 and the carrier substrate 200 to each other, thereby improving the quality of slim display device.

Referring to FIGS. 5 to 9, when using the supporting unit 4 according to the first embodiment of the present invention, the process for bringing the carrier substrate 200 into contact with the substrate 100 supported by the first surface plate 3 may include the following process. First, the supporting unit 4 is lowered so as to bring the first area 210 protruding through the hollow portion 411 into contact with the substrate 100 supported by the first surface plate 3.

This process may be performed by lowering the supporting device 41 using the elevating unit 42. The elevating unit 42 lowers the supporting device 41 when the first area 210 of the carrier substrate 200 protrudes toward the substrate 100 supported by the first surface plate 3 through the hollow portion 411. Thus, as shown in FIG. 8, the first area 210 is first brought into contact with the substrate 100 supported by the first surface plate 3 before the second area 220 is brought into contact with the substrate 100. The process for lowering the supporting unit 4 so as to bring the first area 210 into contact with the substrate 100 can be performed by lowering the supporting device 41 after aligning the substrate 100 and the carrier substrate 200.

Then, the supporting unit 4 is moved so as to be apart from the space between the carrier substrate 200 and the substrate 100, whereby the second area 220 of the carrier substrate 200 is brought into contact with the substrate 100 supported by the first surface plate 3. This process may be performed by moving the supporting device 41 using the moving unit 43. That is, the moving unit 43 moves the supporting device 41 so as to make the supporting device 41 be apart from the space between the carrier substrate 200 and the substrate 100.

Accordingly, as shown in FIG. 9, the second area 220 of the carrier substrate 200 is gradually brought into contact with the substrate 100 by discharging the gas remaining between the carrier substrate 200 and the substrate 100. Thus, this method prevents bubbles from occurring between the substrate 100 and the carrier substrate 200 when bonding the substrate 100 and the carrier substrate 200 to each other, thereby improving the quality of slim display device.

Referring to FIGS. 10 to 15, when using the supporting unit 4 according to the second embodiment of the present invention, the method for manufacturing the bonded substrate according to an embodiment of the present invention includes the following process.

First, the process for positioning the carrier substrate 200 in the supporting unit 4 includes attaching the carrier substrate 200 to the supporting unit 4. This process may be performed by adjusting the suction force so as to make the pressure between the carrier substrate 200 and the supporting unit 4 become gradually higher from the first area 210 to the second area 220. That is, the pressure (P1, See FIG. 11) between the second surface plate 44 and the first area 210 of the carrier substrate 200 is adjusted to be higher than the pressure (P2, P2′, P3, P3′, P4 and P4′, See FIG. 11) between the second surface plate 44 and the second area 220 of the carrier substrate 200.

Also, the pressure (P2, P2′, P3, P′3, P4 and P′4, See FIG. 11) between the second area 220 of the carrier substrate 200 and the second surface plate 44 is gradually decreased from the first area 210 to the second area 220. Next, the process for bring the carrier substrate 200 into contact with the substrate 100 supported by the first surface plate 3 includes gradually lowering the pressure inside the chamber unit 2 to the first pressure.

This process may be performed by gradually lowering the pressure inside the chamber unit 2 so as to make the pressure inside the chamber unit 2 to the first pressure using pressure-adjusting unit 5. The first pressure corresponds to the pressure for separating the entire area of the carrier substrate 200 from the second surface plate 44.

Accordingly, as the pressure-adjusting unit 5 gradually lowers the pressure inside the chamber unit 2, as shown in FIG. 13, the first area 210 of the carrier substrate 200 is first separated from the second surface plate 44 before the second area 220 of the carrier substrate 200 is separated from the second surface plate 44. Accordingly, as the pressure inside the chamber unit 2 is gradually lowered, the portion with the higher pressure between the carrier substrate 200 and the second surface plate 44 is first separated from the second surface plate 44.

When the pressure inside the chamber unit 2 becomes lower than the pressure between the first area 210 and the second surface plate 44, the first area 210 of the carrier substrate 200 is first separated from the second surface plate 44, whereby the first area 210 is first brought into contact with the substrate 100. When the pressure-adjusting unit 5 makes a more gradual decrease of the pressure inside the chamber unit 2, as shown in FIG. 14, the second area 220 is separated from the second surface plate 44 when the pressure inside the chamber unit 2 becomes lower than the pressure between the second area 220 and the second surface plate 44, whereby the second area 220 is brought into contact with the substrate 100.

Then, the process for bonding the carrier substrate 200 to the substrate 100 supported by the first surface plate 3 includes lowering the pressure inside the chamber unit 2 to the second pressure which is lower than the first pressure. This process may be performed by lowering the pressure inside the chamber unit 2 to the second pressure using the pressure-adjusting unit 5 when the entire surface of the carrier substrate 200 is brought into contact with the substrate 100. Accordingly, the pressure-adjusting unit 5 can bond the carrier substrate 200 to the substrate 100 by discharging the gas remaining the substrate 100 and the carrier substrate 200 from the gap therebetween.

Referring to FIGS. 16 to 19, when using the supporting unit 4 according to the third embodiment of the present invention, the method for manufacturing the bonded substrate according to an embodiment of the present invention is similar to that of the above operation of the substrate-bonding apparatus 1.

Referring to FIGS. 20 to 29, when using the supporting unit 4 according to the fourth embodiment of the present invention, the method for manufacturing the bonded substrate according to an embodiment of the present invention may be implemented as follows.

First, the process for positioning the carrier substrate 200 in the supporting unit 4 includes attaching the carrier substrate 200 to the attaching unit 46. This process may be performed by loading the carrier substrate 200 to the inside of the chamber unit 2 using a transferring device, and attaching the loaded carrier substrate 200 to the attaching unit 46. Then, the process for bring the carrier substrate 200 into contact with the substrate 100 supported by the first surface plate 3 includes separating the carrier substrate 200 from the attaching unit 46 so as to bring the carrier substrate 200 into contact with the substrate 100.

This process may be performed by elevating the attaching unit 46 using the first elevating device 47. Accordingly, as the carrier substrate 200 is separated from the attaching unit 46, the carrier substrate 200 descends toward the substrate 100 supported by the first surface plate 3, and then the carrier substrate 200 is brought into contact with the substrate 100.

The process for separating the carrier substrate 200 from the attaching unit 46 includes elevating the attaching unit 46 to the retreat position inside the second surface plate 44. This process may be performed by elevating the attaching unit 46 to the retreat position through the contact position by the use of first elevating device 47. Accordingly, as the attaching unit 46 is elevated to be inserted into the inside of the second surface plate 44 using the first elevating device 47, the attaching unit 46 retreats to be apart from the substrate 100 supported by the first surface plate 3.

During this process, even though the attaching unit 46 is elevated from the contact position to the retreat position, the carrier substrate 200 attached to the attaching unit 46 is separated from the attaching unit 46 because the carrier substrate 200 attached to the attaching unit 46 is supported by the separating unit 48. Accordingly, the carrier substrate 200 descends toward the substrate 100 supported by the first surface plate 3, whereby the carrier substrate 200 is brought into contact with the substrate 100 supported by the first surface plate 3.

Accordingly, in comparison with the damaged substrate 100 by the force applied using pushing pin 300, the diaphragm 400, and the spraying device 500 in FIGS. 2 to 4, the method for manufacturing the bonded substrate according to an embodiment of the present invention brings the carrier substrate 200 into contact with the substrate 100 using the attaching unit 46 without applying the force to the substrate 100 supported by the first surface plate 3. Thus, the method according to an embodiment of the present invention prevents the substrate 100 from being spotted or deformed during the process for bring the carrier substrate 200 into contact with the substrate 100 supported, thereby improving the quality of slim display device using substrate-bonding apparatus 1 according to an embodiment of the present invention.

Referring to FIGS. 20 to 29, the process for separating the carrier substrate 200 from the attaching unit 46 may further include lowering the pressure inside the chamber unit 2 to the first pressure. This process may be performed by lowering the pressure inside the chamber unit 2 using the pressure-adjusting unit 5. Further, the process for lowering the pressure inside the chamber unit 2 to the first pressure can be performed by adjusting the pressure inside the chamber unit 2 to the first vacuum state using the pressure-adjusting unit 5 before the carrier substrate 200 is brought into contact with the substrate 100.

The pressure-adjusting unit 5 can also adjust the pressure inside the chamber unit 2 to the first pressure so as to make the first vacuum state inside the chamber unit 2. Accordingly, the pressure-adjusting unit 5 decreases the gas remaining between the substrate 100 and the carrier substrate 200 when bringing the carrier substrate 200 into contact with the substrate 100.

Further, the process for lowering the pressure inside the chamber unit 2 to the first pressure may be performed by adjusting the pressure inside the chamber unit 2 to the first pressure using the pressure-adjusting unit 5 after the attaching unit 46 is elevated to the contact position. The process for lowering the pressure inside the chamber unit 2 to the first pressure may be performed by adjusting the pressure inside the chamber unit 2 to the first pressure using the pressure-adjusting unit 5 when elevating the attaching unit 46 from the contact position to the retreat position.

When the process for separating the carrier substrate 200 from the attaching unit 46 includes lowering the pressure inside the chamber unit 2 to the first pressure, the process for bonding the carrier substrate 200 to the substrate 100 includes lowering the pressure inside the chamber unit 2 to the second pressure when the carrier substrate 200 is brought into contact with the substrate 100.

The process for lowering the pressure inside the chamber unit 2 to the second pressure may be performed by lowering the pressure inside the chamber unit 2 to the second pressure using the pressure-adjusting unit 5. The pressure-adjusting unit 5 can adjust the pressure inside the chamber unit 2 to the second pressure so as to make the second vacuum state inside the chamber unit 2. The vacuum level of the second vacuum state is higher than that of the first vacuum state.

Thus, the pressure-adjusting unit 5 completely discharges the gas remaining between the substrate 100 and the carrier substrate 200 from the gap between the substrate 100 and the carrier substrate 200, thereby bonding the carrier substrate 200 to the substrate 100.

Referring to FIGS. 20 to 29, the process for elevating the attaching unit 46 includes elevating the attaching unit 46 to the contact position, and the process for elevating the attaching unit 46 to the retreat position. The process for elevating the attaching unit 46 to the contact position may be performed by elevating the attaching unit 46 to the contact position using first elevating device 47. Accordingly, the carrier substrate 200 attached to the attaching unit 46 is brought into contact with the second surface plate 44.

For elevating the attaching unit 46 to the contact position, the attaching unit 46 is stopped when the attaching unit 46 is positioned at the contact position. Thus, when the carrier substrate 200 is separated from the attaching unit 46 according to the elevation of attaching unit 46 to the retreat position, it is possible to decrease the impact applied to the carrier substrate 200. When elevating the attaching unit 46 to the contact position, the speed of elevating the attaching unit 46 is gradually lowered before the attaching unit 46 is positioned at the contact position to decrease the impact applied to the carrier substrate 200 when the carrier substrate 200 is brought into contact with the second surface plate 44.

The process for elevating the attaching unit 46 to the retreat position may be performed by elevating the attaching unit 46 to the retreat position using the first elevating device 47. Accordingly, as the carrier substrate 200 is separated from the attaching unit 46, the carrier substrate 200 is brought into contact with the substrate 100 supported by the first surface plate 3. It is also possible to sequentially perform the process for elevating the attaching unit 46 to the contact position, and the process for elevating the attaching unit 46 to the retreat position.

In this instance, the first elevating device 47 may continuously elevate the attaching unit 46 the retreat position without stopping at the contact position. Thus, the method for manufacturing the bonded substrate according to an embodiment of the present invention decreases the time period consumed for separating the carrier substrate 200 from the attaching unit 46, thereby decreasing the time period for bonding the carrier substrate 200 to the substrate 100.

Referring to FIGS. 20 to 29, the process for separating the carrier substrate 200 from the attaching unit 46 may further include lowering the pushing member 482, and stopping the pushing member 482. The process for lowering the pushing member 482 may be performed by lowering the pushing member 482 using the second elevating device 483. Accordingly, as the pushing member 482 is lowered by the second elevating device 483, the pushing member 482 pushes the diaphragm 481 so that the diaphragm 481 expands.

Thus, the diaphragm 481 pushes the carrier substrate 200 attached to the attaching unit 46, whereby the carrier substrate 200 is separated from the attaching unit 46. When lowering the pushing member 482, the pushing member 482 pushes the diaphragm 481 so that the diaphragm 481 being in surface-contact with the carrier substrate 200 pushes the carrier substrate 200. This process may be performed by lowering the pushing member 482 using the second elevating device 481 so as to move the diaphragm 481 at an entirely-uniform distance. Thus, the method for manufacturing the bonded substrate according to an embodiment of the present invention precisely controls the distance of moving the diaphragm 481 so as to separate the carrier substrate 200 from the attaching unit 46.

In addition, the process for stopping the pushing member 482 may be performed by stopping the pushing member 482 using the second elevating device 483. When the carrier substrate 200 arrives at the position where the carrier substrate 200 is separated from the attaching unit 46 and the substrate 100, the second elevating device 483 can stop the pushing member 482. That is, the process for separating the carrier substrate 200 from the attaching unit 46 may be performed by lowering the pushing member 482 up to the position where the carrier substrate 200 is separated from the attaching unit 46 using the second elevating device 483, and is simultaneously separated from the substrate 100 supported by the first surface plate 3.

Accordingly, the method for manufacturing the bonded substrate according to an embodiment of the present invention prevents the substrate 100 being in contact with the carrier substrate 200 from being pushed by the diaphragm 481 when separating the carrier substrate 200 from the attaching unit 46. Thus, the method for manufacturing the bonded substrate according to an embodiment of the present invention prevents the substrate 100 from being spotted or deformed by the diaphragm 481, thereby improving the quality of slim display device.

In addition, in one embodiment, the substrate 100 and the carrier substrate 200 are formed of glass. However, the substrate 100 and the carrier substrate 200 may be formed of a metal substrate or plastic substrate with flexibility.

Thus, the embodiments of the present invention prevent the substrate 100 from being damaged when manufacturing the display device by bonding the substrate 100 and the carrier substrate 200 to each other, and prevents the substrate 100 from being damage when bonding the substrate 100 and the carrier substrate 200 to each other.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A substrate-bonding apparatus for a display device, the apparatus comprising:
a chamber unit configured to bond a carrier substrate to a substrate for manufacturing the display device;
a first surface plate provided inside the chamber unit and configured to support the substrate;
a supporting unit provided inside the chamber unit and configured bring the carrier substrate into contact with the substrate supported by the first surface plate; and
a pressure-adjusting unit communicating with the chamber unit and configured to change a vacuum pressure from a low vacuum pressure to a high pressure in multiple steps inside the chamber unit while the carrier substrate is brought into contact with the substrate to bond the carrier substrate to the substrate without adhesive material between the carrier substrate and the substrate.

2. The substrate-bonding apparatus according to claim 1, wherein the supporting unit includes a supporting member having a hollow portion allowing a first area of the carrier substrate to protrude towards the substrate and contact the substrate before a second area corresponding to a remaining area except the first area of the carrier substrate contacts the substrate.

3. The substrate-bonding apparatus according to claim 2, further comprising:
an elevating unit configured to raise and lower the supporting member supporting the carrier substrate; and
a moving unit configured to move the supporting member towards and away from the carrier substrate,
wherein the elevating unit lowers the supporting member to bring the first area protruding through the hollow porting into contact with the substrate supported by the first surface plate, and
wherein the moving unit moves the supporting member away from the carrier substrate when the first area contacts the substrate so that the second area is gradually brought into contact with the substrate.

4. The substrate-bonding apparatus according to claim 2, wherein the supporting member includes a diagonal member having a gradually-decreased thickness toward the hollow portion so the first area of the carrier substrate sags by its own weight and simultaneously protrudes through the hollow portion.

5. The substrate-bonding apparatus according to claim 1, further comprising:
a suction unit communicating with the chamber unit and configured to provide a suction force so as to attach the carrier substrate to the supporting unit,
wherein the suction unit adjusts the suction force to make a pressure between the carrier substrate and the supporting unit gradually increase from a first area of the carrier substrate to a second area excluding the first area so that the first area of the carrier substrate first contacts the substrate and then a second area of the carrier substrate is brought into contact with the substrate, and
wherein the pressure-adjusting unit increases the lower vacuum pressure to the higher vacuum pressure in multiple steps inside the chamber unit so as to make the first area first separated from the supporting unit before the second area is separated from the supporting unit.

6. The substrate-bonding apparatus according to claim 1, wherein the chamber unit includes at least one exhaust hole formed at a wall of the chamber unit, and
wherein the pressure-adjusting unit is connected with the at least one exhaust hole so as to change the vacuum pressure inside the chamber unit by discharging gas through both sides of a gap between the substrate and the carrier substrate.

7. The substrate-bonding apparatus according to claim 1, further comprising:
a rotating unit disposed between the first surface plate and the supporting unit and configured to rotate the first surface plate and the supporting unit in opposite directions so that a first area of the carrier substrate first contacts the substrate and then a second area of the carrier substrate excluding the first area contacts the substrate supported by the first surface plate.

8. The substrate-bonding apparatus according to claim 1, wherein the supporting unit includes:
an attaching unit movably provided in the supporting unit and configured to be attached to the carrier substrate; and
a first elevating device connected to the attaching unit and configured to lower and raise the attaching unit,
wherein the first elevating device raises the attaching unit to be retreated to the inside of the supporting unit so that the carrier substrate separated from the attaching unit falls freely toward the substrate supported by the first surface plate.

9. The substrate-bonding apparatus according to claim 8, wherein the first elevating device raises the attaching unit to a contact position where the carrier substrate is brought into contact with the supporting unit, and then continues to raise the attaching unit to a retreat position inside of the supporting unit, and
wherein the supporting includes a retreat groove into which the attaching unit raised to the retreat position is inserted.

10. The substrate-bonding apparatus according to claim 8, wherein the attaching unit includes an attaching member and an attaching pin connecting the elevating device with the attaching member, and
wherein the attaching member includes an adhesive rubber configured to attach the carrier substrate to the attaching unit.

11. The substrate-bonding apparatus according to claim 8, wherein the attaching unit includes an attaching member and an attaching pin connecting the elevating device with the attaching member, and
wherein the attaching member includes an electrode configured to attach the carrier substrate to the attaching member using an electrostatic force.

12. The substrate-bonding apparatus according to claim 8, wherein the supporting unit includes a diaphragm, a pushing member configured to push the diaphragm, and a second elevating device configured to raise and lower the pushing member,
wherein the pushing member brings the diaphragm into surface-contact with the carrier substrate, and
wherein the second elevating device lowers the pushing member to a position where the carrier substrate is separated from the attaching unit and is separated from the substrate supported by the first surface place.

13. A method of bonding a carrier substrate and a substrate for a display device, the method comprising:
supporting, via a first surface plate provided inside the chamber unit, the substrate;
bringing, via using a supporting unit provided inside the chamber unit, the carrier substrate into contact with the substrate supported by the first surface plate; and
changing, via a pressure-adjusting unit communicating with the chamber unit, a vacuum pressure from a low vacuum pressure to a high pressure in multiple steps inside the chamber unit while the carrier substrate is brought into contact with the substrate to bond the carrier substrate to the substrate without adhesive material between the carrier substrate and the substrate.

14. The method according to claim 13, wherein the bringing step further comprises:
allowing, via a supporting member having a hollow portion in the supporting unit, a first area of the carrier substrate to protrude towards the substrate and contact the substrate before a second area corresponding to a remaining area except the first area of the carrier substrate contacts the substrate.

15. The method according to claim 14, wherein the bringing step further comprises:
raising and lowering, via an elevating unit, the supporting member supporting the carrier substrate; and
moving, via a moving unit, the supporting member towards and away from the carrier substrate,
wherein the elevating unit lowers the supporting member to bring the first area protruding through the hollow porting into contact with the substrate supported by the first surface plate, and
wherein the moving unit moves the supporting member away from the carrier substrate when the first area contacts the substrate so that the second area is gradually brought into contact with the substrate.

16. The method according to claim 13, wherein the bringing step further comprises:
providing, via a suction unit communicating with the chamber unit, a suction force so as to attach the carrier substrate to the supporting unit;
adjusting, via the suction unit, the suction force to make a pressure between the carrier substrate and the supporting unit gradually increase from a first area of the carrier substrate to a second area excluding the first area so that the first area of the carrier substrate first contacts the substrate and then a second area of the carrier substrate is brought into contact with the substrate; and
increasing, via the pressure-adjusting unit, the lower vacuum pressure to the higher vacuum pressure in multiple steps inside the chamber unit so as to make the first area first separated from the supporting unit before the second area is separated from the supporting unit.

17. The method according to claim 13, wherein the bringing step further comprises:
rotating, via a rotating unit disposed between the first surface plate and the supporting unit, the first surface plate and the supporting unit in opposite directions so that a first area of the carrier substrate first contacts the substrate and then a second area of the carrier substrate excluding the first area contacts the substrate supported by the first surface plate.

18. The method according to claim 13,
wherein the supporting step further comprises attaching, via a attaching unit of the supporting unit, the carrier substrate;
wherein the bringing step further comprises separating the carrier substrate from the attaching unit; and
wherein the separating step further comprises raising, via a first elevating device connected to the attaching unit and configured to lower and raise the attaching unit, the attaching unit so as to make the attaching unit retreated to the inside of the supporting unit.

19. The method according to claim 18, wherein the separating step further comprises:
raising, via the first elevating device, the attaching unit to a contact position where the carrier substrate is brought into contact with the supporting unit, and
raising, via the first elevating device, the attaching unit to a retreat position inside of the supporting unit.

20. The method according to claim 18, wherein the separating step further comprises:
lowering, via a second elevating device configured to raise and lower a pushing member, the pushing member for pushing a diaphragm so as to make the diaphragm push the carrier substrate in a surface-contact state; and
stopping, via the second elevating device, the pushing member when the carrier substrate is separated from the attaching unit and is separated from the substrate supported by the first surface place.
